(19) United States
(12) Patent Application Publication
(10) Pub. No.: US 2026/0235550 A1
(43) Pub. Date: Aug. 13, 2026

(54) ELECTROPHORESIS DEVICE

(71) Applicant: Hitachi High-Tech Corporation, Tokyo (JP)

(72) Inventors: Chiaki TAKAHOSHI, Tokyo (JP); Taichiro YAMASHITA, Tokyo (JP); Takenori OKUSA, Tokyo (JP); Shunichi KARIYA, Tokyo (JP); Takeshi OOURA, Tokyo (JP); Hiroyasu MATSUURA, Tokyo (JP)

(73) Assignee: Hitachi High-Tech Corporation, Tokyo (JP)

(21) Appl. No.: 19/157,456

(22) PCT Filed: May 26, 2023
(86) PCT No.: PCT/JP2023/019809

§ 371 Date: Aug. 18, 2025

(51) Int. Cl. G01N 27/447

(52) U.S. Cl. CPC G01N 27/44791

(57) ABSTRACT

The electrophoresis device includes a capillary, a container containing a sample, a stage, and a drive portion for driving the stage as well as an engagement member, and a toggle mechanism for toggling the states of the engagement member. Over a trajectory of the stage, one side includes a transfer area capable of transferring the container to the stage. The other side includes a connection area capable of connecting and removing the capillary to/from the container. The toggle mechanism toggles the states of the engagement member in conjunction with the movement of the stage. The disengaged state is activated when the stage is located on one side. The engaged state is activated when the stage is located on the other side. The stage moves horizontally while maintaining the engaged state on one side and maintaining the disengaged state on the other side.

### TECHNICAL FIELD

The present invention relates to an electrophoresis device that performs electrophoresis in a capillary.

### BACKGROUND ART

A capillary electrophoresis device that performs electrophoresis in a capillary is widely used as an electrophoresis device. The capillary is filled with a migration medium as an electrolyte and performs electrophoresis of a sample when voltage is applied to both ends. The capillary may be filled with a polymer gel or polymer solution and used for capillary gel electrophoresis using the molecular sieve effect.

Generally, the capillary electrophoresis device includes a capillary array that integrates multiple capillaries or an autosampler. Electrophoresis samples are stored in a sample plate as a liquid container. The sample plate is available as a micro-well plate, for example. The sample plate may store a buffer solution or a cleaning solution, for example. The sample plate is placed on an autosampler stage and is transported or manipulated variously.

When placed on the stage, the sample plate is covered with a septum. The septum is a lid or a membrane that prevents the liquid from evaporating and is generally made of elastomer. After being covered with the septum, the sample plate is secured to a plate holder and assembled into a sample plate assembly. The assembled sample plate assembly is placed on the autosampler stage.

The capillary array is positioned so that the tips of the capillaries protrude downward. After being placed on the autosampler stage, the sample plate assembly is transported horizontally and positioned below the capillary array. The stage is then driven to ascend. As the sample plate assembly ascends, the capillary, whose relative position is fixed, penetrates the septum and is inserted into the sample plate well to suction the sample, for example.

When the capillary is inserted into the septum, the closed opening elastically deforms and opens. When the capillary is inserted, the opening of the septum generates a restoring force in the direction of closing the opening. This seals the gap between the periphery of the capillary and the inner wall of the opening. When electrophoresis ends, the stage is driven to descend. As the sample plate assembly descends, the capillary, whose relative position is fixed, is pulled out from the well inside above the septum.

When the capillary is pulled out of the septum, a frictional force is generated between the side of the capillary and the inner surface of the septum opening. This frictional force may lift the sample plate assembly placed on the stage. The lifted sample plate assembly may not be able to be transported through the use of the stage. To deal with this issue, a method of fastening the sample plate assembly to the stage is being considered.

The sample plate assembly fastened onto the stage must be able to be unfastened as needed. In the field of electrophoresis devices, it is expected to place multiple sample plate assemblies on the electrophoresis device for continuous analysis. When performing continuous analysis, the movable stage must not only transport the sample plate assembly but also be able to transfer the sample plate assembly, such as detaching and replacing the sample plate assembly. To be able to be transferred, the sample plate assembly must be unfastened over the stage at the transferred location.

Conventionally, various technologies have been proposed to detachably fasten a container, such as a sample plate assembly for containing samples, to a movable stage.

According to the integrated sample-processing system described in Patent Literature 1, “The components of the transport mechanism 5600 act as first and second detachable clamping mechanisms. The first detachable clamping mechanism applies force to the first surface (such as Y or X) of the microplate. The second detachable clamping mechanism applies force to a second surface (such as X or Y) of the microplate. The holder thereby holds the microplate from two sides. The clamping mechanism sandwiches the microplate between a positioning arm and an opposing frame structure. Namely, the positioning arm functions as an extrusion member. The opposing frame structure acts as a bumper for the clamping mechanism.” (C47, L66).

According to the electrophoresis device described in Patent Literature 2, “The solenoid 304 controls opening and closing operations of the electric gripper 127. When current flows through the solenoid 304, the solenoid 304 is driven and the electric gripper 127 opens. When the current flowing through the solenoid 304 stops, the elastic force of the spring 305 closes the electric gripper 127. The electric gripper 127 is opened when the sample container 122 is placed on the stage 301. The electric gripper 127 is closed after the sample container 122 is placed on the stage 301. This makes it possible to hold the sample container 122.” (paragraph 0037).

The electrophoresis device described in Patent Literature 3 “includes a capillary, a stage to place a container containing a sample or a reagent, and an autosampler to move the stage in a horizontal direction parallel to the surface of the stage and in a vertical direction perpendicular to the surface of the stage. The autosampler includes a stopper that applies a downward force to the container when the stage is lowered in the vertical direction to disconnect the container connected to the capillary from the capillary. Transfer of the capillary places the container at a position where at least part of the container faces the stopper.” (paragraph 0007).

### CITATION LIST

### Patent Literature

Patent Literature 1: U.S. Pat. No. 6,902,703
Patent Literature 2: International Publication No. 2021/26951
Patent Literature 3: Japanese Unexamined Patent Application Publication No. 2022-035426

### SUMMARY OF INVENTION

### Technical Problem

In the field of electrophoresis devices, it is required to fasten the container on the stage in order to prevent the container from lifting when the capillary is pulled out from the container that contains a sample, for example. The container fastened to the stage requires being automatically unfastened at the container transfer location so that the container can be automatically removed from the stage or placed on the stage. The means for achieving these performances require a structure that does not occupy a large space around the container or a simple structure that can be embodied at a low cost.

According to Patent Literature 1, the holder is positioned in a predetermined manner by applying force to the microplate on two sides (X and Y) from the clamping mechanism. This method provides no solution to an upward reaction force generated by a downward removal from the capillary. The mechanism presses the microplate sideways and necessitates a structure that easily occupies the space around the container. There is a limitation on the downsizing that can decrease the projected area. When multiple microplates are positioned in parallel, it is difficult to reduce the interval between the microplates.

According to Patent Literature 2, an electric gripper driven by a solenoid is used to prevent the sample container from lifting. However, such an electric mechanism requires a power source and wiring, which are likely to occupy space inside the electrophoresis device. The use of electric mechanisms makes it difficult to reduce costs and simplify the structures.

According to Patent Literature 3, the sample adapter of the sample plate assembly includes a flange engaging with the stopper and a groove allowing the upper surface of the stopper to pass through. However, such a structure breaks the compatibility of the sample plate assembly.

The present invention aims to provide a simply structured electrophoresis device that is suitable for downsizing, can prevent a container from lifting when the capillary is removed from the container, and also properly transfer the container.

### Solution to Problem

To solve the above-described problem, an electrophoresis device according to the present invention includes the capillary; a container for containing a sample or a reagent; a stage for mounting the container; a drive portion for driving the stage at least in a horizontal direction; an engagement member that can toggle between an engaged state to engage the container with the stage and a disengaged state to disengage the container from the stage; and a toggle mechanism that allows the engagement member to toggle between the engaged state and the disengaged state. Over a trajectory of the stage, one side includes a transfer area capable of transferring the container to the stage. The other side includes a connection area capable of connecting and removing the capillary from the container. A first position is provided between the one side and the other side. A second position is provided between the first position and the other side. The toggle mechanism allows the engagement member to enter the disengaged state when the state of the engagement member transitions in conjunction with the movement of the stage between the first position and the second position to position the stage to the one side. The engagement member enters the engaged state when the stage is positioned to the other side. The stage moves horizontally between the one side and the first position while maintaining the engagement member in the engaged state. The stage moves horizontally between the other side and the second position while maintaining the engagement member in the disengaged state.

### Advantageous Effects of Invention

The present invention provides a simply structured electrophoresis device that is suitable for downsizing, can prevent a container from lifting when a capillary is removed from the container, and also properly transfer the container.

### BRIEF DESCRIPTION OF DRAWINGS

FIG. 1 is a schematic diagram illustrating the configuration of an electrophoresis device according to an embodiment of the present invention.

FIG. 2 is a perspective view illustrating the inside of the electrophoresis device according to the embodiment of the present invention.

FIG. 3 is a plan view illustrating the inside of the electrophoresis device according to the embodiment of the present invention.

FIG. 4 is a side view illustrating the inside of the electrophoresis device according to the embodiment of the present invention.

FIG. 5 is a perspective view illustrating a sample plate assembly.

FIG. 6 is a perspective view illustrating an autosampler provided for the electrophoresis device.

FIG. 7 is an exploded perspective view illustrating a holding portion open-close mechanism.

FIG. 8A is a perspective view illustrating the holding portion open-close mechanism in a closed state.

FIG. 8B is a perspective view illustrating the holding portion open-close mechanism in an open state.

FIG. 9A is a cross-sectional view illustrating the autosampler when the holding portion open-close mechanism is closed.

FIG. 9B is a cross-sectional view illustrating the autosampler when the holding portion open-close mechanism is closed.

FIG. 10A is a diagram illustrating the operation of transferring the sample plate assembly to a stage.

FIG. 10B is a diagram illustrating the operation of transferring the sample plate assembly to the stage.

FIG. 11 is a diagram illustrating the operation of the holding portion open-close mechanism equipped with a cam roller.

FIG. 12 is a diagram illustrating the operation of the holding portion open-close mechanism equipped with the cam roller.

FIG. 13 is a diagram explaining the connection positions of the sample plate assembly connected to capillaries.

FIG. 14 is a diagram illustrating the relationship between the position of the stage in the X-axis direction and the open-close state of the holding portion.

FIG. 15A is a diagram illustrating an example shape of the holding portion.

FIG. 15B is an enlarged view illustrating a relevant part of the example shape of the holding portion.

FIG. 16 is a perspective view illustrating the placement of the autosampler and the sample mounting portion.

FIG. 17 is an exploded perspective view of the holding portion open-close mechanism equipped with a magnetic member.

FIG. 18 is a diagram illustrating the magnetic member and magnetic poles functioning as a driven side.

FIG. 19 is a diagram illustrating the magnetic member and magnetic poles functioning as a driving side.

FIG. 20 is a diagram illustrating the operation of the holding portion open-close mechanism equipped with the magnetic member.

FIG. 21 is a perspective view illustrating the autosampler provided for the electrophoresis device.

FIG. 22A is a plan view illustrating the rotation mechanism in a disengaged state.

FIG. 22B is a plan view illustrating the rotation mechanism in an engaged state.

FIG. 23 is a diagram illustrating the relationship between the stage position in the X-axis direction and the engaged state of an engagement blade.

### DESCRIPTION OF EMBODIMENTS

The following describes the electrophoresis device according to the embodiment of the present invention. In each drawing, the same reference numerals are used to designate comparable configurations, and duplicated descriptions will be omitted.

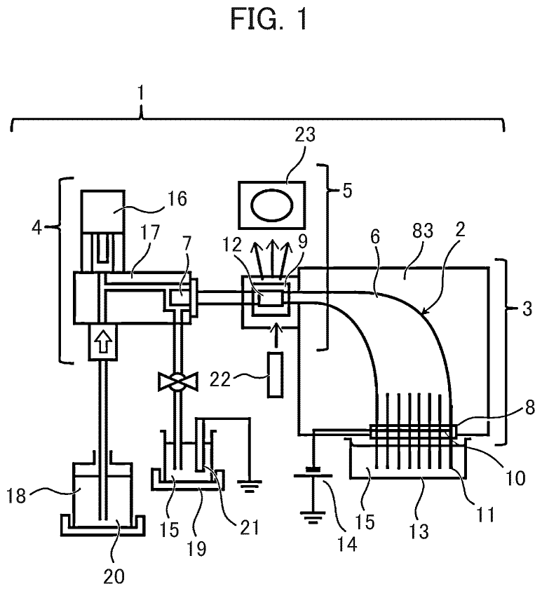

FIG. 1 is a schematic diagram illustrating the configuration of an electrophoresis device according to an embodiment of the present invention.

As illustrated in FIG. 1, an electrophoresis device 1 includes a capillary array 2, an electrophoresis portion 3, a liquid supply portion 4, and an irradiation detection portion 5, for example. The electrophoresis device 1 is a capillary electrophoresis device that performs electrophoresis in a capillary. The electrophoresis device 1 can be used to analyze base sequences of nucleic acids such as DNA and ions, for example.

The capillary array 2 is formed by assembling multiple capillaries 6, a capillary head 7, a load header 8, and a clamp plate 9, for example. The capillary array 2 can be provided as a detachable capillary array unit. The capillary array unit can be attached and detached, making it possible to easily replace the capillary 6 when the capillary 6 is used for a predetermined number of analyses, or when analysis targets or items are changed.

The capillary 6 is a narrow tube and is generally formed by coating the narrow tube made of quartz glass with polyimide. The narrow tube made of quartz glass uses the coat to ensure strength against destruction such as cracks. The coat is removed in the zone corresponding to a detection position 12 of the capillary 6.

The capillary head 7 is attached to a block 17 of the liquid supply portion 4. The capillary head 7 bundles multiple capillaries 6 and connects the anode end of the capillary 6 to the block 17 of the liquid supply portion 4.

The load header 8 is attached to the bottom of the electrophoresis portion 3. The load header 8 clamps the multiple capillaries 6 and a cathode electrode 10. The capillary 6 is clamped to the load header 8 so as to penetrate the cathode electrode 10. The capillary 6 includes a cathode end 11 that protrudes downward of the load header 8.

The clamp plate 9 is attached to the irradiation detection portion 5. The clamp plate 9 includes multiple grooves for aligning the capillary 6. The clamp plate 9 aligns and clamps the multiple capillaries 6. The clamp plate 9 removes the coat from a region of the capillary 6. This region is positioned to the optically flat surface of the detection position 12 as accurately as several micrometers in height.

The electrophoresis portion 3 performs electrophoresis using the capillary array 2. The electrophoresis portion 3 includes a thermostatic bath 83, a cathode-side buffer container 13, and a high-voltage supply 14, for example.

The thermostatic bath 83 houses an intermediate part of the capillaries 6 composing the capillary array 2. The inside of the thermostatic bath 83 is adjusted to a predetermined temperature. For example, a Peltier element is used as the heat source of the thermostatic bath 83. The thermostatic bath 83 can be adjusted to the temperature ranging from a temperature lower than room temperature to a high temperature of 50° C. or higher. The thermostatic bath 83 can include a fan (unshown). The fan can circulate the air inside and reduce spatial temperature variations.

The cathode-side buffer container 13 stores a buffer solution 15. The cathode-side buffer container 13 is provided to be movable relative to the cathode end 11 and the cathode electrode 10 of the capillary 6. The cathode end 11 and the cathode electrode 10 of the capillary 6 are immersed in the buffer solution 15 during electrophoresis.

The high-voltage supply 14 is electrically connected to the cathode electrode 10. The high-voltage supply 14 applies a high voltage between the cathode electrode 10 and an anode electrode 21 during electrophoresis. The voltage, when applied, can move an electric charge inside the capillary 6, generating an electroosmotic flow.

The liquid supply portion 4 delivers a migration medium to the inside of the capillary 6. The liquid supply portion 4 includes a pump 16, the block 17, a polymer container 18, and an anode-side buffer container 19, for example. A high-viscosity polymer solution 20 is used as the migration medium, for example.

The pump 16 is connected to the block 17 of the liquid supply portion 4. The pump 16 delivers the migration medium prepared in the polymer container 18 to the inside of the capillary 6.

The block 17 includes an internal flow path. The block 17 mutually connects the capillary head 7, the pump 16, the polymer container 18, and the anode-side buffer container 19 via the internal flow path.

The polymer container 18 stores the polymer solution 20 as a migration medium. The pump 16 operates to fill the polymer solution 20 stored in the polymer container 18 into the capillary 6 through the block 17.

The anode-side buffer container 19 stores a buffer solution 15. The anode electrode 21 is immersed in the buffer solution 15. The cathode end 11 of the capillary 6 is immersed in the buffer solution 15 contained in the cathode-side buffer container 13. Then, the buffer solution 15 contained in the anode-side buffer container 19 and the buffer solution 15 contained in the cathode-side buffer container 13 are electrically connected via the polymer solution 20 filled in the capillary 6.

The irradiation detection portion 5 optically detects the components separated by electrophoresis inside the capillary 6. The irradiation detection portion 5 includes a light source 22 and a detector 23, for example.

The light source 22 generates excitation light of a specified wavelength and irradiates it onto the detection position 12 of the capillary 6. The coat of the capillary 6 is removed at the detection position 12, permitting light to pass through. The excitation light generated by the light source 22 is irradiated onto components separated by electrophoresis inside the capillary 6.

The detector 23 detects the light emitted from components separated by electrophoresis. The sample may be labeled with a fluorescent dye. Then, the components irradiated with the excitation light emit light such as fluorescence. The excitation light can be irradiated to the components passing through the detection position 12 and the light emitted from the components can be detected. It is possible to detect and quantify the components separated by electrophoresis based on each size.

A control device (unshown) controls the operations of each component of the electrophoresis device 1. The control device is composed of a processor to execute a program for operating the electrophoresis device 1 and memory to store the program, for example.

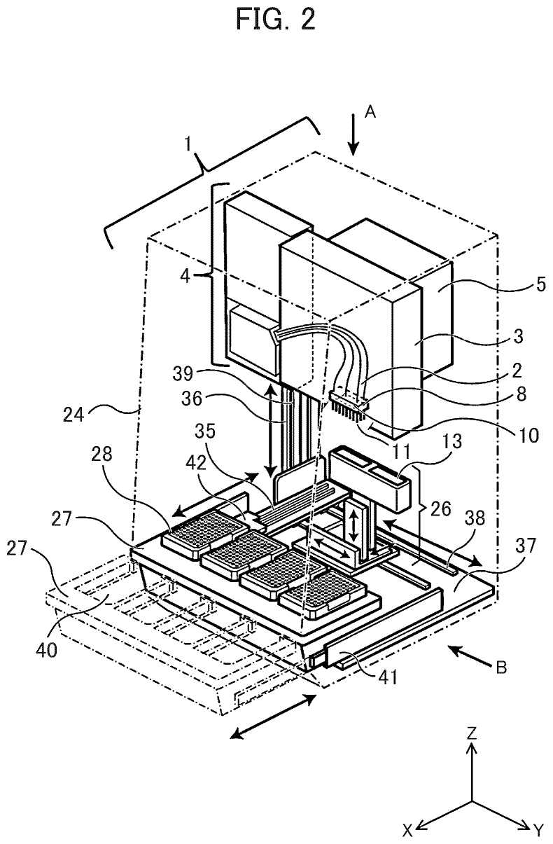

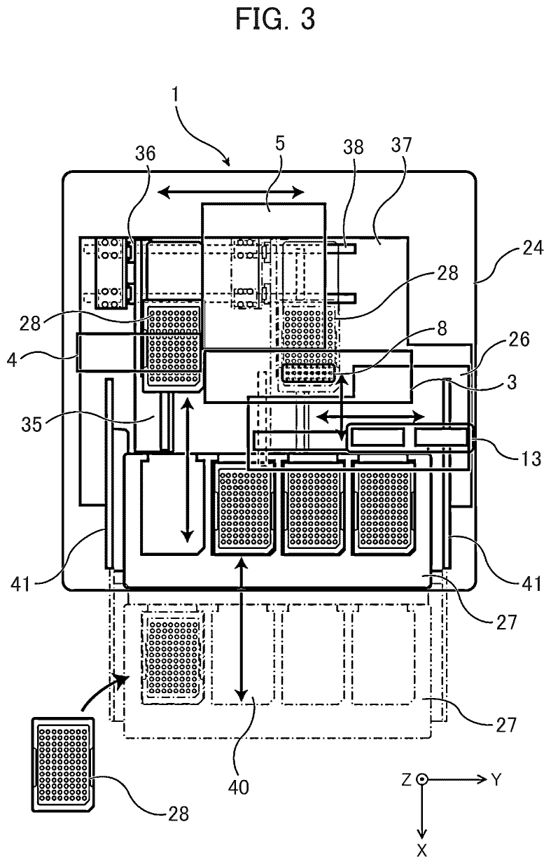

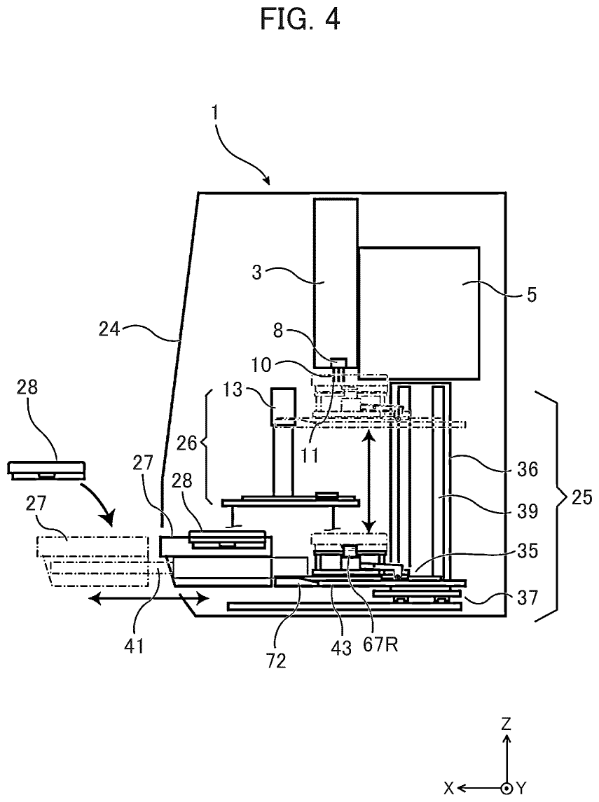

FIG. 2 is a perspective view illustrating the inside of the electrophoresis device according to the embodiment of the present invention. FIG. 3 is a plan view illustrating the inside of the electrophoresis device according to the embodiment of the present invention. FIG. 4 is a side view illustrating the inside of the electrophoresis device according to the embodiment of the present invention. FIGS. 2, 3, and 4 include partial perspective views of an example inside the electrophoresis device. FIG. 3 corresponds to a view from direction A in FIG. 2. FIG. 4 corresponds to a view from direction B in FIG. 2.

As illustrated in FIGS. 2, 3 and 4, the electrophoresis device 1 includes a housing 24, an autosampler 25, a buffer transport portion 26, and a sample mounting portion 27, for example, in addition to the components illustrated in FIG. 1. The control device (unshown) controls the autosampler 25 and the buffer transport portion 26 like the components illustrated in FIG. 1.

The housing 24 contains the main components such as the capillary array 2, the electrophoresis portion 3, the liquid supply portion 4, the irradiation detection portion 5, the autosampler 25, the buffer transport portion 26, and the sample mounting portion 27. The housing 24 can also include an openable door for maintenance or replacement of the components.

The autosampler 25 is provided at the rear of the electrophoresis device 1. The autosampler 25 transports a sample plate assembly 28 to be capable of suctioning and sampling samples, for example. The autosampler 25 is provided so that the sample plate assembly 28 can be moved bidirectionally along three mutually orthogonal axial directions.

The buffer transport portion 26 is provided at the rear of the electrophoresis device 1. The buffer transport portion 26 transports the cathode-side buffer container 13. The buffer transport portion 26 is provided so that the cathode-side buffer container 13 can be moved bidirectionally along at least two axial directions, horizontally and vertically.

In this specification, the X-axis direction and the Y-axis direction correspond to the horizontal direction and conform to the direction parallel to the mounting surface of a stage 34 on which the sample plate assembly 28 is placed. The Z-axis direction corresponds to the vertical direction and conforms to the direction perpendicular to the mounting surface of the stage 34 on which the sample plate assembly 28 is placed. The X-axis direction also corresponds to the front-rear direction of the electrophoresis device 1. The positive direction signifies “front” and the negative direction signifies “rear.” The Y-axis direction also corresponds to the horizontal direction of the electrophoresis device 1. The positive direction signifies “right” and the negative direction signifies “left.” The Z-axis direction also corresponds to the vertical direction of the electrophoresis device 1. The positive direction signifies “up” and the negative direction signifies “down.”

The sample mounting portion 27 allows a user to mount the sample plate assembly 28 from outside the electrophoresis device 1. The sample mounting portion 27 is provided at the front of the electrophoresis device 1. The sample mounting portion 27 includes a slit portion 40 to individually place the sample plate assembly 28.

In a planar view, the slit portion 40 is shaped into a groove slightly larger than the outer shape of the sample plate assembly 28. A receptive plane is formed toward the bottom of the slit portion 40. The receptive plane protrudes inward from the right and left sides of the slit portion 40. The bottom end of the slit portion 40 is open except for the receptive plane. The rear end of the slit portion 40 is open.

The sample plate assembly 28 containing samples, for example, is placed in the slit portion 40 to be supported by the receptive plane from below. Since the bottom and rear ends of the slit portion 40 are open, the stage 34 of the autosampler 25 can easily approach the sample plate assembly 28 placed in the slit portion 40.

As seen from FIGS. 2, 3, and 4, the sample mounting portion 27 is provided like a drawer. A pair of right and left sample mounting portion rails 41 supports the sample mounting portion 27 to be movable in the front-rear direction. The sample mounting portion 27 includes the multiple slit portions 40 provided in parallel to be capable of placing a total of four sample plate assemblies 28. The sample mounting portion 27 can be designed for any structure to place any number of sample plate assemblies 28.

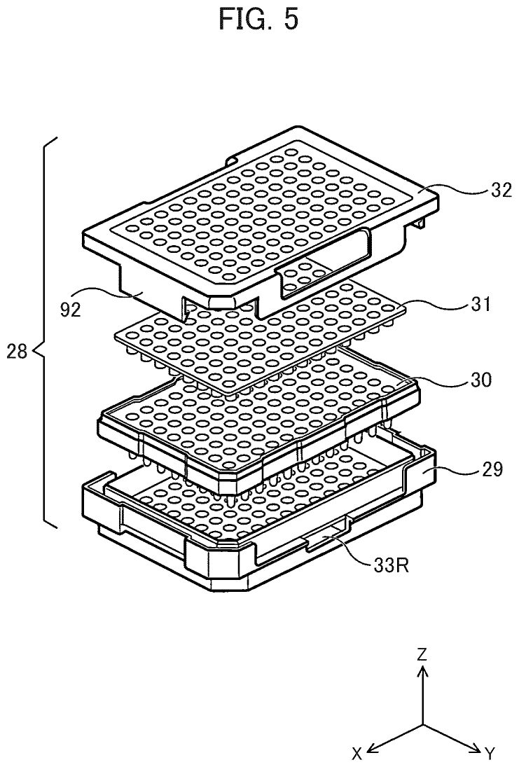

FIG. 5 is a perspective view illustrating a sample plate assembly. FIG. 5 illustrates the sample plate assembly 28 as a container for samples, for example, with the components separated from each other.

As illustrated in FIG. 5, the sample plate assembly 28 is composed of a sample adapter 29, a sample plate 30, a septum 31, and a septum clip 32. The user assembles the sample adapter 29, the sample plate 30, the septum 31, and the septum clip 32 in this order from the bottom so that they are stacked.

The sample adapter 29 supports the sample plate 30 and mediates the placement of the sample plate 30 on the stage 34 of the electrophoresis device 1. The sample adapter 29 is provided as a fitting for the electrophoresis device 1 in order to ensure proper positioning on the stage 34 of the autosampler 25.

The sample plate 30 is a container that stores samples and reagents, for example. The sample plate 30 represents a container referred to as a micro-well plate or a microtiter plate, for example. Such a container includes multiple wells arranged in a rectangular matrix to be capable of containing liquids, for example.

The septum 31 is a lid or a membrane that covers the sample plate 30. The septum 31 includes a bottomed cylindrical portion that protrudes downward at a position corresponding to the well of the sample plate 30. The septum 31 is attached to the sample plate 30 so that the cylindrical portion fits into the well. The bottom of the cylindrical portion includes an opening through which the capillary 6 can be inserted. The septum 31 can cover the well while allowing the capillary 6 to be inserted and removed, thereby preventing the liquid contained in the well from evaporating before and after analysis.

The septum 31 is favorably made of an elastomer such as silicone rubber. When the capillary 6 is inserted into the opening, the elastomer can expand the opening due to elastic deformation and apply a restoring force in a direction to close the opening. The well can remain sealed at a high level, regardless of whether the capillary 6 is inserted into the opening.

The septum clip 32 secures the sample plate 30 and septum 31 to the sample adapter 29. The septum clip 32 is attached to the sample adapter 29 to cover the sample plate 30 and septum 31 from above. The septum clip 32 includes an opening at a position corresponding to the well of the sample plate 30. The cathode end 11 of the capillary 6 is inserted into the inside of the well of the sample plate 30 through the opening of the septum clip 32.

The septum clip 32 includes a nail 92. The nail 92 protrudes downward from both ends of the septum clip 32 in the front-rear direction. A nail catch is provided at both ends of the sample adapter 29 in the front-rear direction to be capable of engaging with the nail 92. When the nail 92 engages with the nail catch, the septum clip 32 can secure the sample plate 30 and the septum 31 to the sample adapter 29 therebetween.

The sample adapter 29 is externally provided into an approximately rectangular parallelepiped shape. The sample adapter 29 includes a top face to place the sample plate 30, a pair of right and left side faces parallel to the front-rear direction, a front face parallel to the horizontal direction, and a rear face parallel to the horizontal direction. The sample adapter 29 is externally shaped into an approximately rectangular parallelepiped whose bottom face is concaved upward and is opened.

The sample adapter 29 includes a holding nail engaging hole 33R on the right side and a holding nail engaging hole 33L (unshown) on the left side. The holding nail engaging holes 33L and 33R are formed as through-holes penetrating the sides of the sample adapter 29 in and out. The bottom face of the sample adapter 29 is open, allowing the outer side of the right and left side faces of the sample adapter 29 to communicate with the lower part of the sample adapter 29 through the holding nail engaging holes 33L and 33R.

Holding nails 67L and 67R are inserted into the holding nail engaging holes 33L and 33R to be engaged. When the holding nail engaging holes 33L and 33R engage with the holding nails 67L and 67R, the sample plate assembly 28 placed on the stage 34 is fastened onto the stage 34. The holding nail engaging holes 33L and 33R are favorably shaped into rectangles so that the width is longer than the height, corresponding to the shape of the holding nails 67L and 67R.

The sample plate assembly 28 functions as a container for storing samples for example, and provides a unit that is automatically transported inside the electrophoresis device 1. When multiple sample plate assemblies 28 are used for analysis in the electrophoresis device 1, the multiple assembled sample plate assemblies 28 are placed on the sample mounting portion 27. Transportation by the autosampler 25 and electrophoresis by the capillary array 2 are performed in units of the sample plate assembly 28.

### Electrophoresis Analysis Method

The following describes the electrophoresis analysis method for samples stored in the sample plate assembly 28 of the electrophoresis device 1.

To electrophoretically analyze a sample, the autosampler 25 is first driven to move the sample plate assembly 28 placed on the sample mounting portion 27 onto the stage 34 of the autosampler 25. Then, the stage 34 mounted with the sample plate assembly 28 is transported below the capillary array 2, and then ascended toward the cathode end 11 of the capillary 6.

The stage 34 ascends the sample plate assembly 28 to a height at which the cathode end 11 of the capillary 6 is immersed in the sample contained in the well of the sample plate 30. The cathode end 11 of the capillary 6, whose relative position is fixed, passes through the opening of the septum 31 and is inserted into the inside of the well of the sample plate 30, ready to suction the sample in the well.

A voltage is applied between the cathode electrode 10 and the anode electrode 21 to introduce samples into the capillary 6 and perform electrophoresis for separating samples. The high-voltage supply 14 applies a high voltage of several kilovolts between the cathode electrode 10 and the anode electrode 21.

The applied voltage introduces the sample prepared in the sample plate 30 into the capillary 6. Then, the autosampler 25 is then driven to lower the stage 34 mounted with the sample plate assembly 28 below the capillary array 2 and remove the cathode end 11 of the capillary 6 from the sample plate assembly 28.

Then, the buffer transport portion 26 is driven to transport the cathode-side buffer container 13, containing the buffer solution 15, below the capillary array 2 and then ascend it toward the cathode end 11 of the capillary 6. The cathode end 11 of the capillary 6 is inserted into the cathode-side buffer container 13 and is immersed in the buffer solution 15.

While the cathode end 11 is immersed in the buffer solution 15, the application of a voltage migrates the sample introduced in the capillary 6 toward the anode end of the capillary 6 in units of components due to the charge on the sample components and an electroosmotic flow. The molecular sieve effect due to the polymer is achieved inside the capillary 6 filled with the polymer solution 20, causing differences in migration speed depending on the size of each component. The migration speed of DNA, for example, increases as the molecular length decreases, and it decreases as the molecular length increases.

Differences in migration speed in the capillary 6 separate the components contained in the sample, corresponding to their sizes. Each component contained in the sample may be labeled with a fluorescent label, for example. Then, the irradiation detection portion 5 can detect the optical intensity of each separated component.

### Configuration of Autosampler

The following describes the configuration of the autosampler 25 included in the electrophoresis device 1.

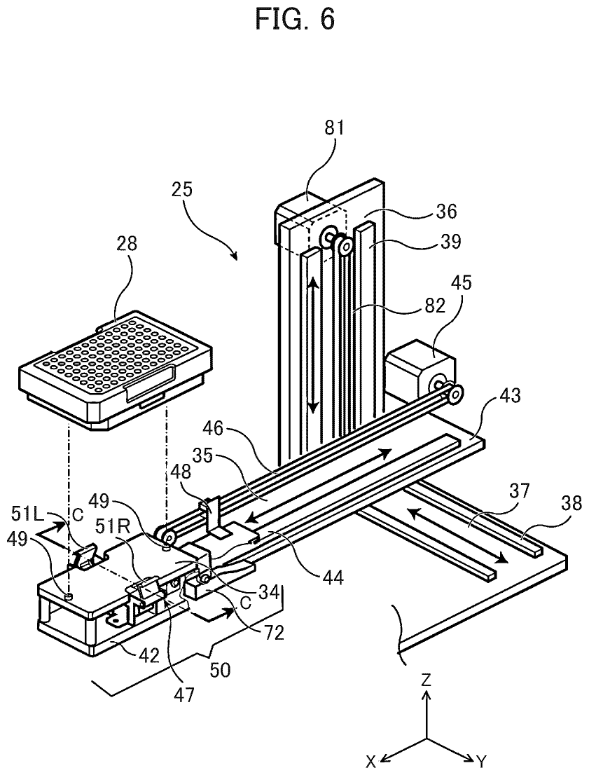

FIG. 6 is a perspective view illustrating an autosampler provided for the electrophoresis device. FIG. 6 shows a partial cutaway view of an example structure of the autosampler 25 included in the electrophoresis device 1.

As illustrated in FIG. 6, the autosampler 25 includes a sliding portion 50 moving along with the stage 34, an X-axis drive portion 35, a Z-axis drive portion 36, and a Y-axis drive portion 37, for example.

The stage 34 serves as a mounting location for transporting the sample plate assembly 28. The stage 34 is supported above a stage base 42. The stage 34 and the stage base 42, for example, form the sliding portion 50 that moves integrally along the X-axis direction. The stage 34 is shaped into a flat plate having a level top face. The autosampler 25 is driven to automatically transfer the sample plate assembly 28, placed on the sample mounting portion 27, onto the stage 34.

The X-axis drive portion 35 drives the sliding portion 50 bidirectionally in the X-axis direction. The X-axis drive portion 35 transports the stage 34 in the front-rear direction. The X-axis drive portion 35 is secured to the Z-axis drive portion 36. The X-axis drive portion 35 includes a plate-like X-axis drive base 43 that extends parallel to the XY plane. An X-axis guide rail 44 is installed on the top face of the X-axis drive base 43 to extend along the X-axis direction. The sliding portion 50 is guided along the X-axis guide rail 44.

A drive source 45 is provided at one end of the X-axis drive base 43. The drive source 45 is composed of a stepping motor that drives the step motion, for example. A pulley is provided at the other end of the X-axis drive base 43. An X-axis drive belt 46 runs between the output shaft of the drive source 45 and the pulley along the X-axis direction. A drive connection member 48 connected to the sliding portion 50 is secured to the X-axis drive belt 46. The rotational motion of the X-axis drive belt 46 drives the sliding portion 50 to move along the X-axis guide rail 44.

The Z-axis drive portion 36 drives the sliding portion 50 and the X-axis drive portion 35 in the Z-axis direction. The Z-axis drive portion 36 transports the stage 34 in the vertical direction. The Z-axis drive portion 36 is secured to the Y-axis drive portion 37. The Z-axis drive portion 36 includes a plate-like body extending parallel to the ZX plane. A Z-axis guide rail 39 is installed on the principal surface of the body to extend along the Z-axis direction. The X-axis drive portion 35 is guided along the Z-axis guide rail 39.

A drive source 81 is provided at one end of the Z-axis drive portion 36. The drive source 81 is composed of a stepping motor that drives the step motion. A pulley is provided at the other end of the Z-axis drive portion 36. An Z-axis drive belt 82 runs between the output shaft of the drive source 81 and the pulley along the Z-axis direction. A drive connection member (unshown) connected to the sliding portion 50 is secured to the Z-axis drive belt 82. The rotational motion of the Z-axis drive belt 82 drives the sliding portion 50 to move along the Z-axis guide rail 39.

The Y-axis drive portion 37 drives the sliding portion 50, the X-axis drive portion 35, and the Z-axis drive portion 36 in the Y-axis direction. The Y-axis drive portion 37 transports the stage 34 in the horizontal direction. The Y-axis drive portion 37 includes a plate-like body extending parallel to the XY plane. A Y-axis guide rail 38 is installed on the principal surface of the body to extend along the Y-axis direction. The Y-axis drive portion 37 is guided along the Z-axis guide rail 39. The sliding portion 50 is driven to move along the Y-axis guide rail 38 according to a mechanism similar to the X-axis drive portion 35 and the Z-axis drive portion 36.

The X-axis drive portion 35, the Z-axis drive portion 36, and the Y-axis drive portion 37 transport the stage 34 through the X-axis zone between the sample mounting portion 27 and the space below the capillary array 2, the Y-axis zone for the sample mounting portion 27, the Z-axis zone for the sample mounting portion 27, and the Z-axis zone below the capillary array 2. The sample mounting portion 27 ascends the sample plate assembly 28 placed in the slit portion 40 from below for the purpose of transfer.

A positioning pin 49 is provided on the top face of the stage 34 to protrude upward. The positioning pin 49 is provided to be capable of engaging with a positioning hole in the bottom face of the sample adapter 29. When the sample plate assembly 28 placed in the slit portion 40 is lifted from below, the engagement between the positioning pin 49 and the positioning hole positions the sample plate assembly 28 to the stage 34.

The sample plate assembly 28 is transferred to the stage 34, transported horizontally toward the bottom of the capillary array 2, and then transported vertically upward toward the cathode end 11 of the capillary 6. As the sample plate assembly 28 mounted on the stage 34 ascends, the capillary 6 penetrates the septum 31 and is inserted into the well of the sample plate 30.

When the capillary 6 is inserted, the opening of the septum 31 expands due to elastic deformation, connecting the inside and outside of the well. When the capillary 6 is inserted into the opening of the septum 31, a restoring force is generated in the direction of closing the opening, sealing the gap between the side face of the capillary 6 and the inner wall of the opening in the septum 31. When electrophoresis ends, the stage 34 descends and the sample plate assembly 28 is pulled out below the cathode end 11 of the capillary 6.

When the capillary 6 is pulled out of the opening of the septum 31, a frictional force is generated between the side of the capillary 6 and the inner surface of the opening of the septum 31. This frictional force may lift the sample plate assembly 28 above the stage 34. The sample plate assembly 28 can be prevented from lifting by fastening the sample plate assembly 28 onto the stage 34.

The sample plate assembly 28 can be prevented from lifting by fastening the sample plate assembly 28 onto the stage 34. However, the sample mounting portion 27 needs to mount the sample plate assembly 28 from the stage 34 to the slit portion 40 and from the slit portion 40 to the stage 34. The sample plate assembly 28 needs to be unfastened in order to be mounted freely.

According to the present embodiment, the electrophoresis device 1 uses a mechanism that can detachably fasten the sample plate assembly 28 onto the stage 34. The sample plate assembly 28 may be misaligned in the X-axis direction on the sample mounting portion 27, located at one end of the trajectory in the X-axis direction of the stage 34. It would be advantageous to increase a high degree of freedom for positions in the X-axis direction. The mechanism for fastening the sample plate assembly 28 needs to be activated and inactivated at the middle of the trajectory in the X-axis direction of the stage 34.

The mechanism for fastening the sample plate assembly 28 includes an engagement member that engages and fastens the sample plate assembly 28 to the side of the stage 34. The engagement member can toggle between an engaged state of engaging the sample plate assembly 28 with the stage 34 and a disengaged state of disengaging the sample plate assembly 28 from the stage 34. The engagement member is installed on the sliding portion 50 to fix the relative position referring to the stage 34.

A toggle mechanism is provided to toggle the engagement member between the engaged state and the disengaged state. The toggle mechanism is configured to toggle the states of the engagement member in conjunction with the movement of the stage 34 so that the sample plate assembly 28 can be fastened and unfastened from the stage 34 without using additional power.

### First Embodiment

According to the first embodiment, the electrophoresis device 1 uses the engagement member represented by holding portions 51L and 51R that rotate around a central axis parallel to the horizontal direction to open and close. The toggle mechanism to toggle the engagement member states uses a cam mechanism that operates in conjunction with the movement of the stage 34. The cam mechanism driver uses a cam member 72 including an inclined cam surface 73 provided on the trajectory of the stage 34 in the X-axis direction. The cam mechanism follower uses a holding portion open-close mechanism 47, including a cam roller 60 functioning as a cam follower. The holding portion open-close mechanism 47 includes the holding portions 51L and 51R as well as the cam roller 60 and moves along with the stage 34.

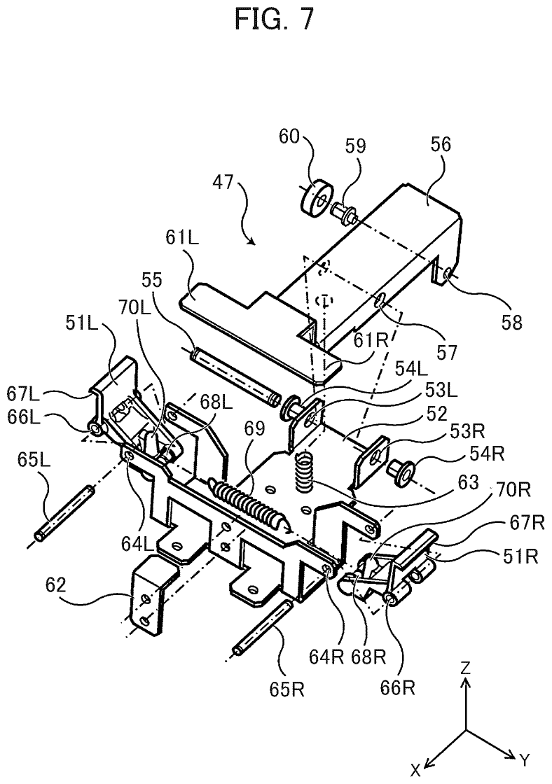

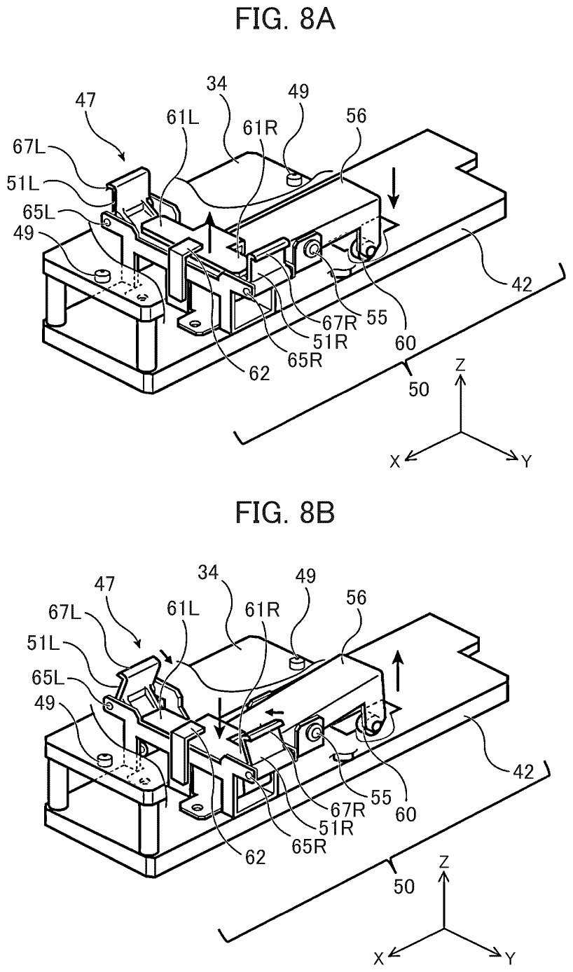

FIG. 7 is an exploded perspective view illustrating a holding portion open-close mechanism. FIG. 8A is a perspective view illustrating the holding portion open-close mechanism in a closed state. FIG. 8B is a perspective view illustrating the holding portion open-close mechanism in an open state. FIG. 7 is an exploded perspective view illustrating the holding portion open-close mechanism 47 including the holding portions 51L and 51R and the cam roller 60. FIGS. 8A and 8B illustrate the sliding portion formed by assembling the holding portion open-close mechanism 47 on the stage base 42.

As illustrated in FIGS. 7, 8A and 8B, FIGS. 8A and 8B illustrate the sliding portion formed by assembling the holding portion open-close mechanism 47 on the stage base 42. According to the first embodiment, the holding portion open-close mechanism 47 includes the cam roller 60, which functions as the cam mechanism follower.

The holding portion open-close mechanism 47 is formed by assembling the left holding portion 51L, the right holding portion 51R, and an oscillating member 56 to a holding portion base member 52, serving as the base. The holding portion base member 52 is secured to the top face of the stage base 42. The stage 34 is supported above the stage base 42 by a supporting post erected on the top face of the stage base 42. The holding portion open-close mechanism 47 is provided below the stage 34 and fastens the sample plate assembly 28, mounted on the stage 34, from below.

A pair of left and right first support shaft holes 53L and 53R are provided at the rear of the holding portion base member 52. To penetrate in the horizontal direction, the first support shaft holes 53L and 53R are drilled in upward directed parts of the holding portion base member 52. The first support shaft holes 53L and 53R are provided approximately symmetrically to the right and left.

The first support shaft holes 53L and 53R are fitted with lubricative bushings 54L and 54R, respectively, into which a first support shaft 55 is inserted. The first support shaft 55 is supported rotatably at the rear of the holding portion base member 52. The first support shaft 55 is provided rotatably around a central axis parallel to the horizontal direction. A retaining ring (unshown), for example, prevents the first support shaft 55 from slipping.

The oscillating member 56 is supported above the holding portion base member 52. Pressing portions 61L and 61R are provided at the front of the oscillating member 56. The cam roller 60 is attached to the rear of the oscillating member 56. A second support shaft hole 57 is provided in the middle of the oscillating member 56 in the front-rear direction. To penetrate in the horizontal direction, the second support shaft hole 57 is drilled in downward directed parts of the oscillating member 56.

The first support shaft 55 is inserted into the second support shaft hole 57. The oscillating member 56 is supported rotatably by the first support shaft 55 parallel to the horizontal direction. The oscillating member 56 is provided swingably using the first support shaft 55 as a fulcrum so that one side and the other side seesaw around the first support shaft 55.

A cam roller pin hole 58 is provided at the rear of the oscillating member 56. To penetrate in the horizontal direction, the cam roller pin hole 58 is drilled in the downward directed parts of the oscillating member 56. A cam roller pin 59 is secured to the cam roller pin hole 58. The cam roller 60 is secured to the cam roller pin 59 by welding or swaging. The cam roller 60 is provided rotatably around a central axis parallel to the horizontal direction at the rear of the oscillating member 56.

At the front, the oscillating member 56 includes a planar portion that is formed to extend in the horizontal direction and the front-rear direction to present a T-shape viewed from above. The left side of this portion functions as the pressing portion 61L that presses one end of the left holding portion 51L. The right side of this portion functions as the pressing portion 61R that presses one end of the right holding portion 51R.

The pressing portions 61L and 61R press the ends of the holding portions 51L and 51R, thereby mechanically fastening and unfastening the sample plate assembly 28 from the stage 34. The pressing portions 61L and 61R are favorably positioned higher than the second support shaft hole 57. According to this positioning, the pressing portions 61L and 61R can generate a large moment when the oscillating member 56 oscillates.

A stopper 62 is provided at the front of the holding portion base member 52. The stopper 62 is provided to extend rearward from a predetermined height relative to the top face of the holding portion base member 52. The stopper 62 restricts the upper limit of the height of the pressing portions 61L and 61R that operate in the vertical direction. The pressing portions 61L and 61R ascend to a predetermined height and touch the stopper 62, thereby limiting the range of the oscillating movement of the oscillating member 56.

A compression spring 63 is provided in the middle of the holding portion base member 52 in the front-rear direction. One end of the compression spring 63 is secured to the top face of the holding portion base member 52. The other end of the compression spring 63 is secured to the bottom face of the oscillating member 56, rearward of the pressing portions 61L and 61R and forward of the second support shaft hole 57. The compression spring 63 is installed between the top face of the holding portion base member 52, forward of the first support shaft holes 53L and 53R, and the bottom face of the oscillating member 56, forward of the second support shaft hole 57.

The compression spring 63 elastically supports the front of the oscillating member 56. When the cam roller 60 can descend, the compression spring 63 applies force to ascend the front of the oscillating member 56. This application of force keeps the pressing portions 61L and 61R in contact with the stopper 62. The state of the oscillating member 56 can be stabilized. When the cam roller 60 ascends, the front of the oscillating member 56 descends to press the compression spring 63. In this state, the pressing portions 61L and 61R can press one end of the holding portions 51L and 51R.

Third support shaft holes 64L and 64R are provided for the front of the holding portion base member 52 at the left and right side ends, respectively. The left third support shaft hole 64L and the right third support shaft hole 64R are each formed of a pair of through-holes spaced apart in the front-rear direction. The third support shaft holes 64L and 64R are drilled in the front-rear direction to penetrate an upwardly directed part of the holding portion base member 52. The third support shaft holes 64L and 64R are provided approximately symmetrically to the right and left.

Second support shafts 65L and 65R are inserted into the third support shaft holes 64L and 64R, respectively. The second support shafts 65L and 65R are rotatably supported at the left and right side ends at the front of the holding portion base member 52. The second support shafts 65L and 65R are rotatably provided around a central axis parallel to the front-rear direction. The second support shafts 65L and 65R rotatably support the holding portions 51L and 51R.

The holding portions 51L and 51R are provided bilaterally symmetrically in terms of the shape, structure, and operation so that they form a pair on the left and right sides. In FIG. 7, the holding portions 51L and 51R are each provided so that a flat plate shaped like a rectangular parallelepiped is bent obtusely. Fourth support shaft holes 66L and 66R are provided in the intermediate bent part of the holding portions 51L and 51R. The fourth support shaft holes 66L and 66R are drilled to penetrate in the front-rear direction.

The second support shafts 65L and 65R are inserted into the fourth support shaft holes 66L and 66R, respectively. The second support shafts 65L and 65R rotatably support the holding portions 51L and 51R, respectively. The holding portions 51L and 51R are rotatably provided around the second support shafts 65L and 65R so that one end and the other end, sandwiching the second support shafts 65L and 65R, ascend and descend alternately.

The holding nails 67L and 67R are formed on one end of the holding portions 51L and 51R. The holding nails 67L and 67R are provided as nail-shaped protrusions projecting from the lateral surface of one end of the holding portions 51L and 51R to be able to project sideways or downward from the one end of the holding portions 51L and 51R.

The holding nails 67L and 67R are formed linearly along the front-rear direction to correspond to the holding nail engaging holes 33L and 33R provided on the side face of the sample adapter 29. The holding nails 67L and 67R are formed with flat bottom faces that can touch the lower inner walls of the holding nail engaging holes 33L and 33R. The holding nails 67L and 67R are inserted into and engage with the holding nail engaging holes 33L and 33R and function as a displacement suppression portion that inhibits the sample adapter 29 from being displaced upward.

The holding portions 51L and 51R include spring hook portions 68L and 68R and pressing protrusion portions 70L and 70R formed at the other end. The spring hook portions 68L and 68R are shaped like rods and are installed in the front-rear direction. The pressing protrusion portions 70L and 70R are provided outward from the spring hook portions 68L and 68R. The pressing protrusion portions 70L and 70R are shaped into protrusions projecting upward so as not to interfere with the surroundings.

A tension spring 69 is stretched between the spring hook portions 68L and 68R. The tension spring 69 applies force in a direction to bring the inner ends of the right and left holding portions 51L and 51R close to each other. This application of force provides an effect of laterally projecting the holding nails 67L and 67R provided outward from the holding portions 51L and 51R. The effect upward projects the pressing protrusion portions 70L and 70R provided inward of the holding portions 51L and 51R.

The pressing portions 61L and 61R press the pressing protrusion portions 70L and 70R. The pressing protrusion portions 70L and 70R are positioned to overlap the pressing portions 61L and 61R according to a planar view of the holding portion open-close mechanism 47. The tip surfaces of the pressing protrusion portions 70L and 70R are favorably curved like a sphere. The curved surface can generate a large suppress strength in the direction of changing the opening degrees, regardless of the opening degrees of the holding portions 51L and 51R.

The oscillating member 56 oscillates so that one side and the other side sandwiching the first support shaft 55 ascend and descend alternately. The front side of the oscillating member 56 ascends to descend the rear side. The front side of the oscillating member 56 descends to ascend the rear side. When the cam roller 60 ascends, the pressing portions 61L and 61R descend, pressing the pressing protrusion portions 70L and 70R of the holding portions 51L and 51R. When the cam roller 60 descends, the pressing portions 61L and 61R ascend, releasing the press onto the pressing protrusion portions 70L and 70R.

The holding portions 51L and 51R can toggle between a closed state and an open state according to the rotation around the second support shafts 65L and 65R. In the closed state, the outside where the holding nails 67L and 67R are formed is directed upward. In the open state, the outside where the holding nails 67L and 67R are formed tilts inward to be positioned more inward than upward.

The pressing portions 61L and 61R ascend to a predetermined height, touch the stopper 62, and do not ascend any higher. The maximum height of the pressing protrusion portions 70L and 70R is limited to the position in contact with the pressing portions 61L and 61R that touch the stopper 62. The maximum height of the pressing protrusion portions 70L and 70R corresponds to the maximum opening degree of the holding portions 51L and 51R. The opening degree of the holding portions 51L and 51R can be adjusted by adjusting the height of the stopper 62.

As illustrated in FIG. 8A, when the cam roller 60 descends, the front of the oscillating member 56 ascends to release the pressing onto the pressing protrusion portions 70L and 70R caused by the pressing portions 61L and 61R. Consequently, the outside of the holding portions 51L and 51R stands upright and is directed upward. This state corresponds to the closed state of the holding portions 51L and 51R.

When the holding portions 51L and 51R remain in the closed state, the holding nails 67L and 67R are inserted into the holding nail engaging holes 33L and 33R of the sample adapter 29 to enter an engaged state. In the closed state, the inner ends of the holding portions 51L and 51R are directed inward to be horizontal or are lowered inward to tilt slightly. In the closed state, the sample plate assembly 28 placed on the stage 34 is fastened onto the stage 34.

As illustrated in FIG. 8B, when the cam roller 60 ascends, the front of the oscillating member 56 descends. The pressing portions 61L and 61R press the pressing protrusion portions 70L and 70R. As a result, the outer sides of the holding portions 51L and 51R tilt and are directed inward. This state corresponds to the open state of the holding portions 51L and 51R.

When the holding portions 51L and 51R are in the open state, the holding nails 67L and 67R are in the disengaged state, allowing them to be released from the holding nail engaging holes 33L and 33R of the sample adapter 29. In the open state, the inner ends of the holding portions 51L and 51R are lowered inward to tilt deeply. In the open state, the sample plate assembly 28 is unfastened from the stage 34.

The amount of displacement of each component of the holding portion open-close mechanism 47 depends on the amount of displacement of the cam roller 60 in the vertical direction, within the range regulated by the stopper 62. Each component of the holding portion open-close mechanism 47 can go into an intermediate state while the holding portions 51L and 51R toggle between the closed state and the open state. The amount of displacement of the cam roller 60 in the vertical direction is changed by the cam member 72, including the inclined cam surface 73 provided on the trajectory of the stage 34 in the X-axis direction.

The main structure of the holding portion open-close mechanism 47 can be made of an appropriate material such as steel, carbon steel, stainless steel, or aluminum alloy. The holding portions 51L and 51R can also be formed by resin molding. It is preferable to use polyacetal, for example, as the resin because of its excellent wear resistance and sliding properties.

### Transfer Operation of Sample Plate Assembly

The following describes the operation of transferring the sample plate assembly 28 to the stage 34 and the cam member 72 provided on the trajectory of the stage 34 in the X-axis direction.

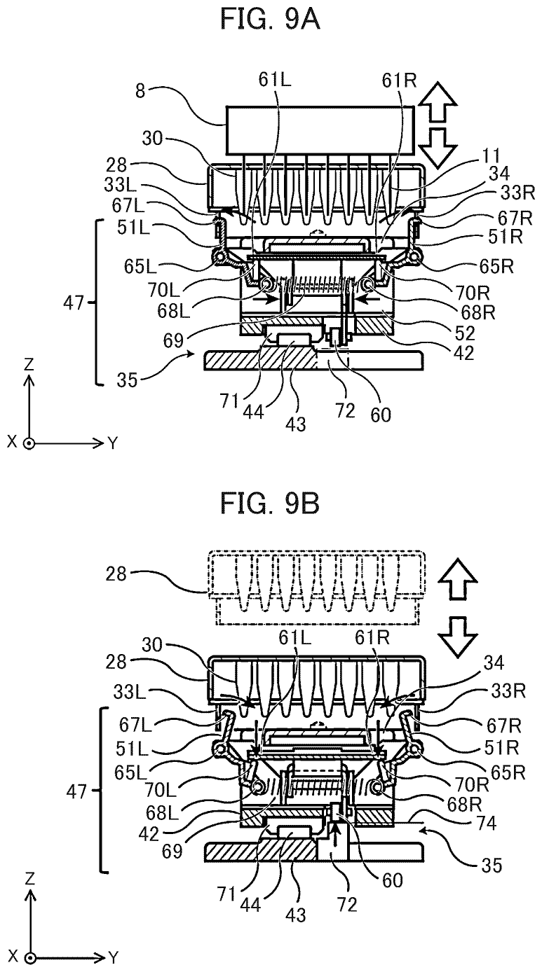

FIG. 9A is a cross-sectional view illustrating the autosampler when the holding portion open-close mechanism is closed. FIG. 9B is a cross-sectional view illustrating the autosampler when the holding portion open-close mechanism is closed. FIGS. 9A and 9B correspond to a cross-sectional view taken along line C-C of FIG. 6. FIGS. 9A and 9B show the state of placing the sample plate assembly 28 on the stage 34. The sample mounting portion 27 is not shown in FIGS. 9A and 9B.

As illustrated in FIGS. 9A and 9B, an X-axis slider 71 supports the stage base 42. The X-axis slider 71 is placed on the X-axis guide rail 44 provided on the X-axis drive base 43 to be movable bidirectionally along the X-axis direction.

The cam member 72 is secured to the X-axis drive base 43. The top face of the cam member 72 includes the inclined cam surface 73 formed to ascend and descend the cam roller 60. The cam member 72 is placed parallel to the X-axis guide rail 44 so that the tilt direction of the inclined cam surface 73 is parallel to the X-axis guide rail 44. The cam member 72 can be provided as long as it is parallel to a partial zone of the X-axis guide rail 44.

As illustrated in FIG. 9A, in a zone where the cam member 72 is not inserted, the cam roller 60 descends without touching the inclined cam surface 73. This state releases the pressing portions 61L and 61R from pressing the pressing protrusion portions 70L and 70R. The tension spring 69 applies force in the tensile direction to upwardly direct the outer sides of the holding portions 51L and 51R where the holding nails 67L and 67R are formed. The holding nails 67L and 67R are inserted into the holding nail engaging holes 33L and 33R of the sample adapter 29 from the inside toward the outside, thus entering the engaged state.

In the engaged state, the holding nails 67L and 67R inhibit the sample plate assembly 28 from being displaced upward. Even if an attempt is made to descend the sample plate assembly 28 by removing it from the cathode end 11 of the capillary 6, the holding nails 67L and 67R apply a downward force to fasten the sample plate assembly 28 onto the stage 34. Consequently, the sample plate assembly 28 can be prevented from lifting.

In a zone where the cam member 72 is inserted, as illustrated in FIG. 9B, the cam roller 60 touches the inclined cam surface 73 and ascends. In this state, the pressing portions 61L and 61R press the pressing protrusion portions 70L and 70R. The outer sides of the holding portions 51L and 51R, forming the holding nails 67L and 67R, tilt and are directed inward against the force applied by the tension spring 69. The holding nails 67L and 67R are disengaged from and are not inserted into the holding nail engaging holes 33L and 33R, entering the disengaged state.

In the disengaged state, the holding nails 67L and 67R do not restrict the upward displacement of the sample plate assembly 28. The holding nails 67L and 67R move inward from the holding nail engaging holes 33L and 33R and retract to such a position as to generate a gap against the side face of the sample adapter 29. In this state, the sample plate assembly 28 placed on the stage 34 can be freely attached and detached in the vertical direction.

As illustrated in FIGS. 9A and 9B, according to a planar view, the holding portions 51L and 51R extend upward from just below the sample adapter 29 inside its outer edge, pass through the opened bottom face of the sample adapter 29, and reach inward of the holding nail engaging holes 33L and 33R. The holding nails 67L and 67R can toggle between the engaged state, inserted into the holding nail engaging holes 33L and 33R from the inside to the outside, and the disengaged state, disengaged from the holding nail engaging holes 33L and 33R.

According to a planar view, this structure allows the holding portions 51L and 51R to operate inside the outer edge of the sample adapter 29. The engaged state maximizes the width in the horizontal direction, making it difficult to protrude outward in the horizontal direction. It is not necessary to ensure space for the holding portion open-close mechanism 47 around the sample plate assembly 28. It is possible to reduce the area occupied by the mechanism for fastening the container and save space inside the electrophoresis device 1.

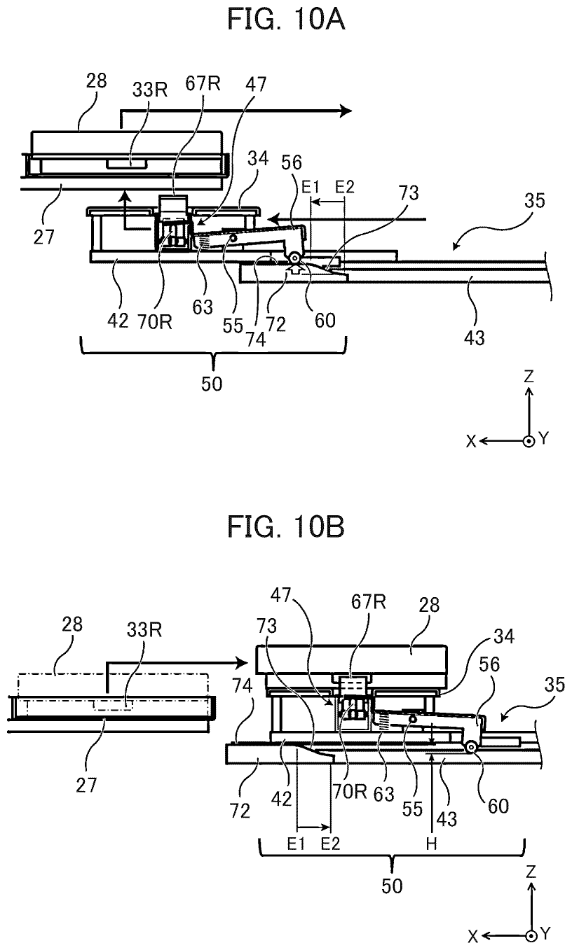

FIGS. 10A and 10B are diagram illustrating the operation of transferring the sample plate assembly to a stage. FIGS. 10A and 10B illustrate the periphery of the sample mounting portion 27, viewed from the Y-axis direction. FIG. 10A illustrates the state before the sample plate assembly 28 mounted on the sample mounting portion 27 is transferred to the stage 34. FIG. 10B illustrates the state after the sample plate assembly 28 mounted on the sample mounting portion 27 is transferred to the stage 34.

As illustrated in FIGS. 10A and 10B, the cam member 72 can be provided on one end of the X-axis drive base 43, close to the sample mounting portion 27. The cam member 72 can be secured to the side face or top face of the X-axis drive base 43. The cam member 72 is provided as high as it touches the descended cam roller 60.

In FIGS. 10A and 10B, as side views, the cam member 72 is shaped into an approximate trapezoid and is provided in a rectangular parallelepiped shape whose one side tilts along the longitudinal direction. The cam member 72 includes a slantingly provided inclined cam surface 73 and a horizontally provided flat cam surface 74 on the top face. The cam member 72 is installed so that the tilt direction of the inclined cam surface 73 is parallel to the trajectory of the stage 34 in the X-axis direction.

The inclined cam surface 73 is provided on the rear top face of the cam member 72 and is positioned toward the rear of the electrophoresis device 1. The inclined cam surface 73 tilts to increase the height from the rear to the front. The inclined cam surface 73 functions as a driver that displaces the cam roller 60 in the vertical direction.

The flat cam surface 74 is provided on the front top face of the cam member 72 and is positioned toward the front of the electrophoresis device 1. The flat cam surface 74 is provided as a substantially horizontal plane. The flat cam surface 74 enables the stage 34 to move without substantially displacing the cam roller 60 in the vertical direction. The flat cam surface 74 can ensure a zone to maintain the disengaged state, making it possible to eliminate the need for precise alignment of the sample plate assembly 28.

As illustrated in FIGS. 10A and 10B, while the cam member 72 is shaped into an approximate trapezoid, the inclined cam surface 73 and the flat cam surface 74 may be connected via a curved surface. The inclined cam surface 73 can be provided at an appropriate tilt angle according to the design of the holding portion open-close mechanism 47. The cam member 72 can be appropriately provided in terms of the height, width, length, and a length ratio between the inclined cam surface 73 and the flat cam surface 74 according to the design of the holding portion open-close mechanism 47.

As illustrated in FIG. 10A, before the sample plate assembly 28 mounted on the sample mounting portion 27 is transferred to the stage 34, the sliding portion 50 is controlled so that the stage 34 is positioned lower than the sample mounting portion 27. The sliding portion 50 is then moved in the X-axis direction to be positioned below the sample mounting portion 27. Then, the X-axis drive base 43 is moved in the Z-axis direction to ascend the sliding portion 50.

The cam roller 60 touches the cam member 72 while the sliding portion 50 moves in the X-axis direction. The cam roller 60 ascends along the inclined cam surface 73 from an E2 position, the bottom end of the inclined cam surface 73, to an E1 position, the top end of the inclined cam surface 73. Therefore, between the E2 position and the E1 position, the state of the holding portion open-close mechanism 47 gradually changes to indicate intermediate values, corresponding to the height of the cam roller 60. The holding portion open-close mechanism 47 gradually changes the states of the holding portions 51L and 51R and the holding nails 67L and 67R as the stage 34 moves between the E2 position and the E1 position.

When the cam roller 60 passes through the E1 position, the holding nails 67L and 67R disengage from the holding nail engaging holes 33L and 33R of the sample adapter 29 and enter the disengaged state. At and after the E1 position, the flat cam surface 74 regulates the height of the cam roller 60 to be approximately constant. At and after the E1 position, an approximately constant disengaged state is maintained to prevent the holding nails 67L and 67R from being displaced.

Even after the holding nails 67L and 67R enter the disengaged state, the sliding portion 50 continues moving in the X-axis direction and stops below the sample mounting portion 27. The sliding portion 50 stops at a position where the X-axis positions of the holding nails 67L and 67R coincide with the X-axis positions of the holding nail engaging holes 33L and 33R. Then, the sliding portion 50 moves upward to transfer the sample plate assembly 28 to the stage 34.

According to this operation, the holding nails 67L and 67R enter the disengaged state when the sample plate assembly 28 is transferred to the stage 34. It is possible to avoid interference between the holding nails 67L and 67R and the sample plate assembly 28. The holding nails 67L and 67R enter the disengaged state at the E1 position before the stop position. It is possible to avoid interference between the holding nails 67L and 67R and the sample plate assembly 28 even if the sample plate assembly 28 is misaligned in the X-axis direction. It is possible to omit precise alignment of the sample plate assembly 28 relative to the sample mounting portion 27. The state of the holding portion open-close mechanism 47 changes gradually, causing no sudden movements. It is possible to uniform the state of the holding nails 67L and 67R over a long zone.

As illustrated in FIG. 10B, after the sample plate assembly 28, mounted on the sample mounting portion 27, is transferred to the stage 34, the sliding portion 50 is moved in the X-axis direction toward the other end of the X-axis trajectory of the stage 34 where the capillary array 2 is mounted.

While the sliding portion 50 retreats to the rear of the sample mounting portion 27, the cam roller 60 moves along the flat cam surface 74, and then descends along the inclined cam surface 73 from the E1 position, as the upper end of the inclined cam surface 73, to the E2 position, as the lower end of the inclined cam surface 73. Between the E1 position and the E2 position, the state of the holding portion open-close mechanism 47 gradually changes to indicate intermediate values, corresponding to the height of the cam roller 60. The holding portion open-close mechanism 47 gradually changes the states of the holding portions 51L and 51R and the holding nails 67L and 67R as the stage 34 moves between the E2 position and the E1 position. The cam roller 60 lowers by the height H of the inclined cam surface 73.

When the cam roller 60 passes through the E2 position, the holding nails 67L and 67R enter the holding nail engaging holes 33L and 33R of the sample adapter 29 and enter the engaged state. At and after the E2 position, the cam roller 60 maintains an approximately constant height because it is freed from the cam member 72. At and after the E2 position, an approximately constant engaged state is maintained to prevent the holding nails 67L and 67R from being displaced.

Even after the holding nails 67L and 67R enter the engaged state, the sliding portion 50 continues moving in the X-axis direction and stops below the sample mounting portion 27. Then, the sliding portion 50 moves upward to insert the capillary 6 into the well of the sample plate 30 of the sample plate assembly 28 and suction the sample. After electrophoresis is completed, the sliding portion 50 moves downward to remove the capillary 6 from the sample plate assembly 28 while the engaged state is maintained.

According to this operation, the holding nails 67L and 67R enter the engaged state when the capillary 6 is removed from the sample plate assembly 28. It is possible to prevent the sample plate assembly 28 from lifting due to the frictional force between the side face of the capillary 6 and the inner surface of the opening of the septum 31. The holding nails 67L and 67R enter the engaged state at the E2 position before the stop position. It is possible to fasten the sample plate assembly 28 while the sample plate assembly 28 is transported in the X-axis direction and the capillary 6 is inserted into the sample plate assembly 28. The state of the holding portion open-close mechanism 47 changes gradually, causing no sudden movements. It is possible to uniform the state of the holding nails 67L and 67R over a long zone.

In the electrophoresis device 1, the sliding portion 50 includes the stage 34 that provides a transfer area and a connection area at both ends along the X-axis trajectory. The transfer area, located at one end in the X-axis direction, enables the transfer of the sample plate assembly 28 onto stage 34. The connection area, located at the other end in the X-axis direction, allows the capillary 6 to connect and disconnect from the sample plate assembly 28. The holding portion open-close mechanism 47 can operate over such a trajectory in conjunction with the movement of the stage 34.

The X-axis trajectory of the stage 34 includes the E1 position and the E2 position between one side, where the transfer area is located, and the other side, where the connection area is located. The E1 position corresponds to the upper end of the inclined cam surface 73. The E2 position corresponds to the lower end of the same. The E1 position serves as the first position where the transition to the disengaged state ends and the transition to the engaged state begins. The E2 position serves as the first position where the transition to the engaged state ends and the transition to the engaged state begins.

The first and second positions can be provided in a predetermined order at appropriate locations on the X-axis trajectory of the stage 34. The cam member 72 can be provided at an appropriate position on the X-axis drive base 43 so that the inclined cam surface 73 and the flat cam surface 74 ensure appropriate lengths. However, from the viewpoint of fastening and stably holding the moving sample plate assembly 28, the first and second positions are preferably positioned toward the transfer area form the center of the X-axis trajectory of the stage 34.

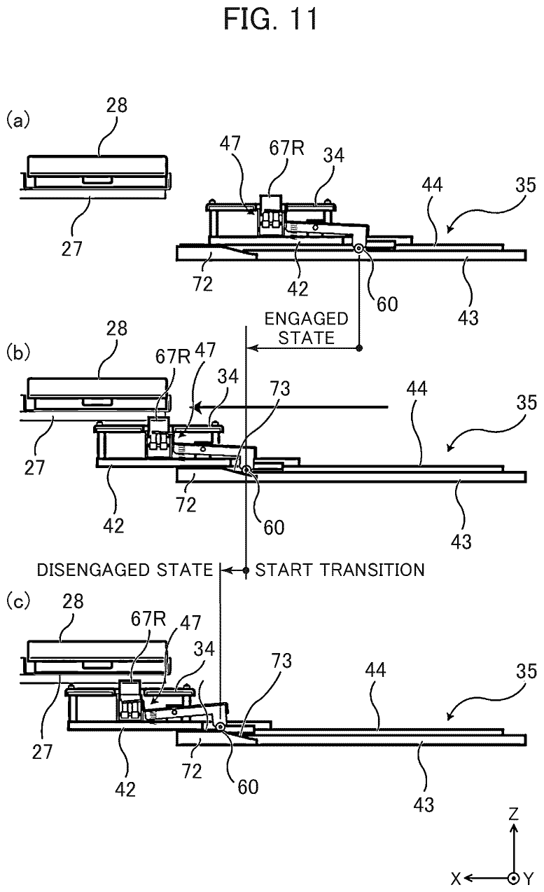

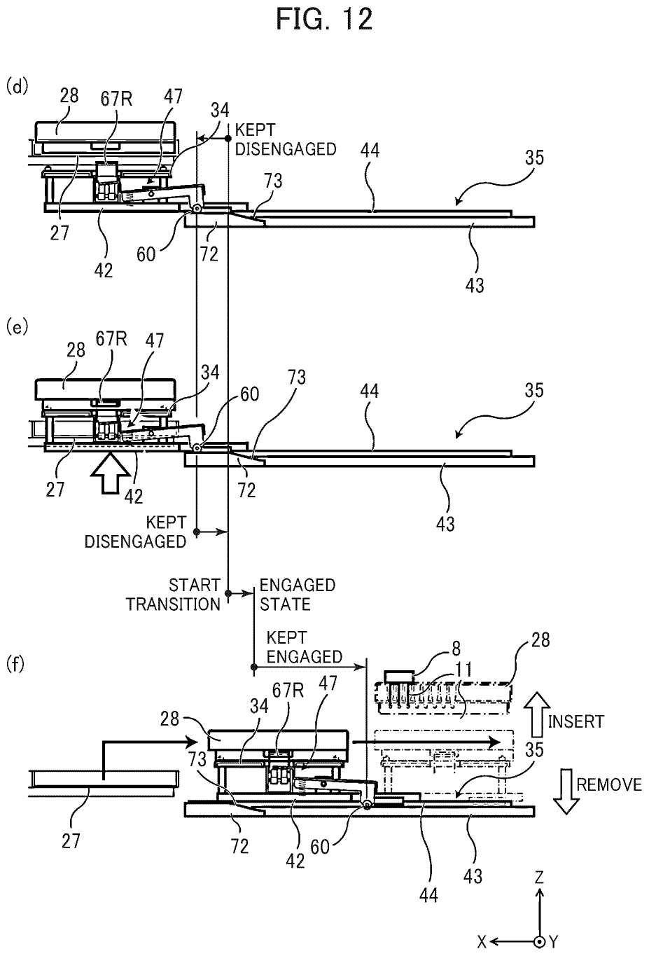

FIGS. 11 and 12 are diagram illustrating the operation of the holding portion open-close mechanism equipped with a cam roller. FIGS. 11 and 12 illustrate the periphery of the holding portion open-close mechanism 47 that supports the stage 34, viewed from the Y-axis direction. The time-based process of transporting the stage 34 follows (a), (b), and (c) sequentially in FIG. 11, and (d), (e), and (f) sequentially in FIG. 12.

The sample plate assembly 28 is mounted on the sample mounting portion 27 and then transferred onto the stage 34. Before the sample plate assembly 28 is transferred, the stage 34 is transported rearward of the sample mounting portion 27 by the drive of the X-axis drive portion 35, the Z-axis drive portion 36, and the Y-axis drive portion 37.

Before the sample plate assembly 28 is transferred, the stage 34 is controlled to a height lower than the bottom face of the sample plate assembly 28 mounted on the sample mounting portion 27. The stage 34 is then transported below the sample mounting portion 27 by the drive of the X-axis drive portion 35.

As illustrated in FIG. 11(a), the stage 34 is away from the sample mounting portion 27. In this state, the cam roller 60 is positioned behind the cam member 72. The cam roller 60 does not touch the cam member 72. At this moment, the holding nails 67L and 67R remain in an engaged state.

As illustrated in FIG. 11(b), the stage 34 approaches the sample mounting portion 27. The cam roller 60 touches the cam member 72 and starts to ascend along the inclined cam surface 73. At this moment, the holding nails 67L and 67R start to transition from the engaged state to the disengaged state.

As illustrated in FIG. 11(c), the stage 34 further approaches the sample mounting portion 27. The cam roller 60 stops ascending along the inclined cam surface 73. At this moment, the holding nails 67L and 67R stop transitioning from the engaged state to the disengaged state and enter the disengaged state.

As illustrated in FIG. 12(d), the stage 34 reaches immediately below the sample mounting portion 27. The X-axis positions of the holding nails 67L and 67R are controlled to coincide with the X-axis positions of the holding nail engaging holes 33L and 33R of the sample plate assembly 28 mounted on the sample mounting portion 27. The positioning pin 49 on the top face of the stage 34 and the positioning hole in the bottom face of the sample adapter 29 are positioned approximately concentrically. At this moment, the holding nails 67L and 67R remain in a disengaged state.

As illustrated in FIG. 12(e), the stage 34 ascends from below the sample mounting portion 27. The slit portion 40 of the sample mounting portion 27 is open on the bottom face. The sample plate assembly 28 mounted on the sample mounting portion 27 is transferred like it is scooped up. The positioning pin 49 on the top face of the stage 34 fits into the positioning hole in the bottom face of the sample adapter 29. Therefore, the sample plate assembly 28 is positioned at a predetermined position on the stage 34. At this moment, the holding nails 67L and 67R remain in a disengaged state.

As illustrated in FIG. 12(f), the X-axis drive portion 35 drives and transports the stage 34 toward the rear of the sample mounting portion 27. The stage 34 moves from above the sample mounting portion 27 to above the X-axis drive base 43 and then is transported to the connection area for electrophoresis. While the stage 34 is transported toward the rear of the sample mounting portion 27, the cam roller 60 descends to its original height along the inclined cam surface 73. The holding nails 67L and 67R transition from the disengaged state to the engaged state.

In FIG. 12(f) and FIG. 3, dash-dot lines represent the structure and operation around the sample plate assembly 28 in the connection area. As illustrated in FIG. 12(f), the cathode end 11 of the capillary 6 protrudes vertically downward. Consequently, the stage 34 is transported below the cathode end 11 of the capillary 6 by the drive of the X-axis drive portion 35 and the Y-axis drive portion 37, and then transported upward by the drive of the Z-axis drive portion 36.

In the connection area, the stage 34 ascends toward the cathode end 11 of the capillary 6, whose relative position is fixed. The capillary 6 thereby penetrates the septum 31 and is inserted into the well of the sample plate 30. The stage 34 ascends while the holding nails 67L and 67R remain engaged. The capillary 6 is inserted into the sample plate assembly 28. After electrophoresis ends, the stage 34 descends to remove the sample plate assembly 28 below the capillary 6. The stage 34 descends while the holding nails 67L and 67R remain engaged. The capillary 6 remains removed from the sample plate assembly 28.

When the capillary 6 is pulled out of the opening of the septum 31, a frictional force is generated between the side of the capillary 6 and the inner surface of the opening of the septum 31. The sample plate assembly 28 may be unfastened, causing too small a force to remove the sample plate assembly 28 downward. In such a case, the sample plate assembly 28 may lift from the stage 34 due to the frictional force and remain inserted in the cathode end 11.

However, the holding nails 67L and 67R transition to the engaged state, while the stage 34 moves, and remain inserted laterally into the holding nail engaging holes 33L and 33R provided in the side face of the sample adapter 29. The stage 34 is driven to descend so that the holding nails 67L and 67R generate a downward force greater than the frictional force generated between the capillary 6 and the septum 31.

The holding nails 67L and 67R remain in the engaged state, applying a downward force to the sample plate assembly 28, and generate a large force to remove the sample plate assembly 28 downward. The sample plate assembly 28 can be effectively prevented from lifting from the stage 34.

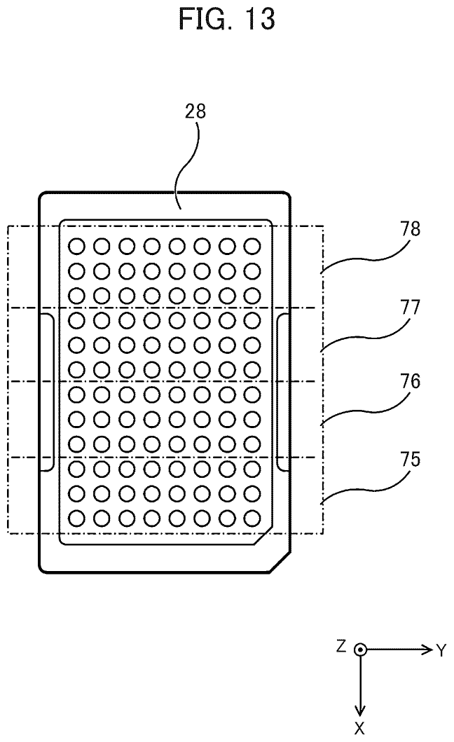

FIG. 13 is a diagram explaining the connection positions of the sample plate assembly connected to capillaries. FIG. 13 illustrates the sample plate assembly 28 viewed in the Z-axis direction. Reference numerals 75 through 78 represent the respective connection positions. As illustrated in FIG. 13, the sample plate assembly 28 includes the connection positions. Multiple connection positions may be provided.

The connection position specifies the wells in the sample plate 30 where the capillaries 6 forming the capillary array 2 are inserted or removed simultaneously. The number of connection positions depends on the number of wells in the sample plate 30 and the number of capillaries 6 that form the capillary array 2.

In FIG. 13, for example, the sample plate 30 includes 12 rows of wells along the X-axis direction and 8 rows of wells along the Y-axis direction, resulting in a total of 96 wells. Suppose the capillary array 2 is formed of 3 rows of capillaries 6 along the X-axis direction and 8 rows of capillaries 6 along the Y-axis direction. In this case, the number of connection positions is 4, as indicated by reference numerals 75 through 78. The following description defines reference numeral 75 as a K position, 76 as an L position, 77 as an M position, and 78 as an N position.

Each connection position requires alignment with the cathode ends 11 for the capillaries 6 that form the capillary array 2. The configuration illustrated in FIG. 13 requires suctioning the sample prepared in the wells while aligning with the K position, the L position, the M position, and the N position in order. It also requires aligning the sample plate assembly 28 at least in the X-axis direction.

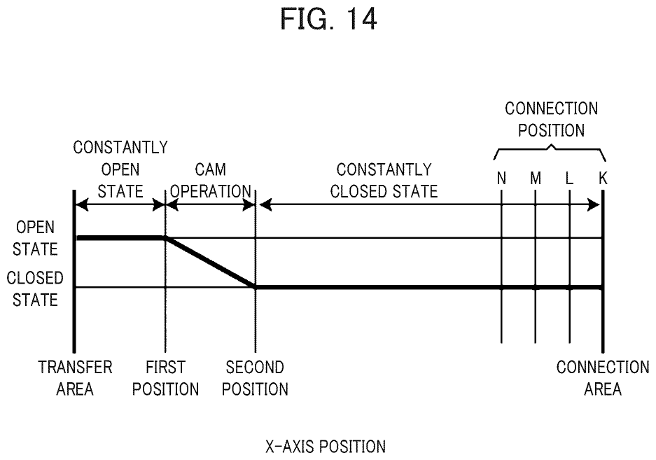

FIG. 14 illustrates the relationship between the stage positions in the X-axis direction and the open/closed state of the holding portion. In FIG. 14, the horizontal axis indicates the positions of the stage 34 in the X-axis direction. The vertical axis indicates the opening degree of the holding portions 51L and 51R corresponding to the movement of the holding nails 67L and 67R. The left end of the horizontal axis indicates the transfer area. The right end of the horizontal axis indicates the connection area. In FIG. 14, the K position is aligned with the connection area.

As illustrated in FIG. 14, the opening degree of the holding portions 51L and 51R toggles between the open state and the closed state in conjunction with the movement of the stage 34 in the X-axis direction. The approximately constantly open state is maintained toward the transfer area in the X-axis direction. On the other hand, the approximately constantly closed state is maintained toward the connection area in the X-axis direction. The opening degree gradually varies while remaining in an intermediate state between the first and second positions, which are located between the transfer area and the connection area.

The first position corresponds to the El position, which is the upper end of the inclined cam surface 73. The first position completes the transition of the holding portions 51L and 51R to the open state and starts the transition of the holding portions 51L and 51R to the closed state. Toward the transfer area from the first position, the holding nails 67L and 67R remain disengaged to unfasten the sample plate assembly 28 from the stage 34.

The second position corresponds to the E2 position, which is the lower end of the inclined cam surface 73. The second position completes the transition of the holding portions 51L and 51R to the closed state and starts the transition of the holding portions 51L and 51R to the open state. Toward the connection area from the second position, the holding nails 67L and 67R enter the engaged state to fasten the sample plate assembly 28 onto the stage 34.

As illustrated in FIG. 14, when multiple connection positions are specified, the second position is preferably located toward the transfer area away from all the connection positions. This configuration can allow the holding nails 67L and 67R to maintain the engaged state closer toward the connection area from the second position. The sample plate assembly 28 can be reliably fastened onto the stage 34 at all connection positions.

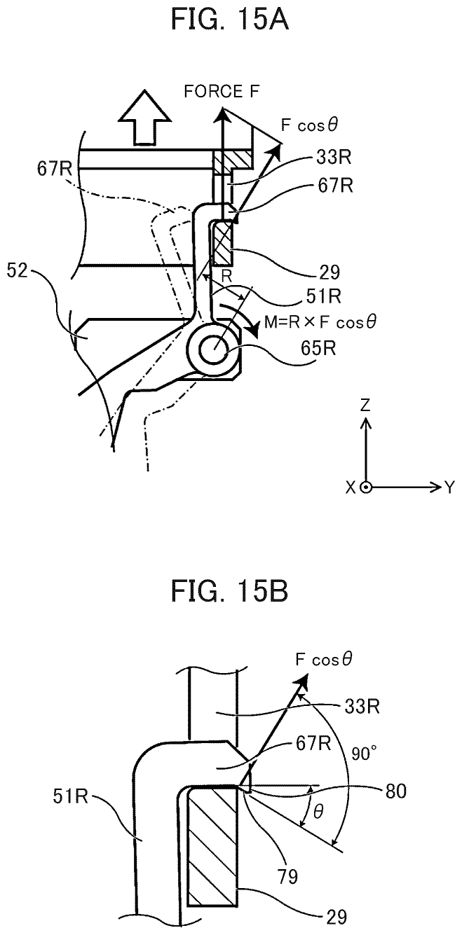

FIG. 15A is a diagram illustrating an example shape of the holding portion. FIG. 15B is an enlarged view illustrating a relevant part of the example shape of the holding portion. FIGS. 15A and 15B are partial cross-sectional views of the holding portion 51R viewed from the X-axis direction, engaging the holding portion 67R with the right holding nail engaging hole 33R. In FIG. 15A, a solid line represents the engaged state of the holding portion 67R, and a dash-dot line represents the disengaged state of the holding portion 67R.

As illustrated in FIGS. 15A and 15B, the right holding portion 51R can include a holding nail 67R and a bent portion 80. The holding nail 67R can extend horizontally through rotation around the second support shaft 65R. The bent portion 80 is provided at the tip of the holding nail 67R and protrudes in a direction perpendicular to the holding nail 67R. Similarly, the left holding portion 51L can include a holding nail 67L and the bent portion 80. The holding nail 67L can extend horizontally through rotation around the second support shaft 65L. The bent portion 80 is provided at the tip of the holding nail 67L and protrudes in a direction perpendicular to the holding nail 67L.

It is preferable that the sample plate assembly 28 mounted on the stage 34 hardly slips from the stage 34 even when the capillary 6 is not inserted or removed. The bent portion 80 provided on the tip of the holding nails 67L and 67R can prevent the engaged holding nails 67L and 67R from being disengaged even if a large unintended upward force is applied to the holding nails 67L and 67R.

When the holding nails 67L and 67R are inserted into the holding nail engaging holes 33L and 33R to enter the engaged state, the bent portion 80 is positioned outside the holding nail engaging holes 33L and 33R. The bent portion 80 can be shaped to include an inclined surface 79. When the holding nails 67L and 67R are inserted into the holding nail engaging holes 33L and 33R, the inclined surface 79 is positioned to face the lower inner wall of the holding nail engaging holes 33L and 33R. The inclined surface 79 is shaped so that the protrusion width perpendicular to the holding nails 67L and 67R increases from the base to the tip of the holding nails 67L and 67R.

As illustrated in FIG. 15B, the inclined surface 79 can be provided to ensure a predetermined angle θ between the inclined surface 79 and the base end of the holding nails 67L and 67R in contact with the lower inner wall of the holding nail engaging holes 33L and 33R. Angle θ between the inclined surface 79 and the base end of the holding nails 67L and 67R is favorably formed to generate a predetermined rotational moment that prevents the engaged state from being released.

For example, suppose upward force F acts on the sample plate assembly 28. In such a case, if the bent portion 80 is not provided, the holding nails 67L and 67R rotate due to upward force F around the second support shafts 65L and 65R to move the tip side inward and are going to slip from the holding nail engaging holes 33L and 33R. Such a slip is noticeable in the holding portions 51L and 51R made of resin.

When the inclined surface 79 having appropriate angle θ is provided, the holding nails 67L and 67R are going to slip from the holding nail engaging holes 33L and 33R and allow the inclined surface 79 to touch the outer corner of the inner wall of the holding nail engaging holes 33L and 33R, thereby generating a component force F cosθ in a direction perpendicular to the inclined surface 79. Therefore, a rotational moment M=R×F cosθ can be generated in terms of distance R between the bent portion 80 and the center of the second support shafts 65L and 65R.

The bent portion 80 makes it possible to appropriately set the angle θ of the inclined surface 79 and the distance R between the bent portion 80 and the center of rotation. The holding nails 67L and 67R are going to slip from the holding nail engaging holes 33L and 33R and touch the inner wall or periphery of the holding nail engaging holes 33L and 33R, making it possible to generate a reaction force in the direction along which the holding nails 67L and 67R are inserted into the holding nail engaging holes 33L and 33R. It is possible to make it difficult for the holding nails 67L and 67R to be disengaged accidentally.

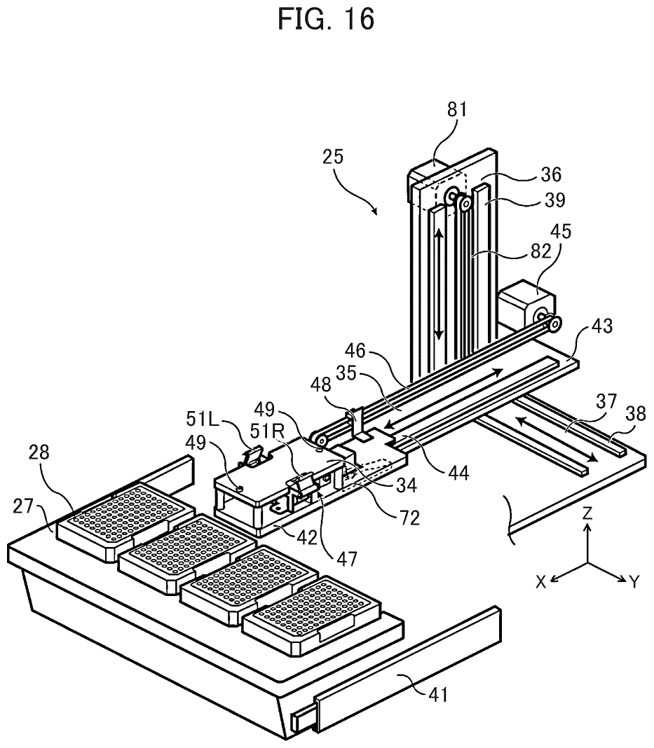

FIG. 16 is a perspective view illustrating the placement of the autosampler and the sample mounting portion. FIG. 16 shows a partial cutaway view of an example structure of the autosampler 25 and the sample mounting portion 27 included in the electrophoresis device 1.

As illustrated in FIG. 16, the sample mounting portion 27 can mount multiple sample plate assemblies 28 in parallel. The autosampler 25 transports the stage 34 in the Y-axis direction to transfer each sample plate assembly 28.

As illustrated in FIGS. 9A and 9B, according to a planar view, the holding portions 51L and 51R extend from just below and inward of the outer edge of the sample plate assembly 28, pass through the opened bottom face of the sample adapter 29, and reach inward of the holding nail engaging holes 33L and 33R.

The holding nails 67L and 67R provided at the tip of the holding portions 51L and 51R can toggle between the engaged state, inserted into the holding nail engaging holes 33L and 33R from the inside to the outside, and the disengaged state, removed inward from the holding nail engaging holes 33L and 33R.

According to a planar view, the holding portions 51L and 51R are positioned inside the outer edge of the sample plate assembly 28 and can operate inside the outer edge of the sample plate assembly 28. The holding nails 67L and 67R are displaced inside the outer edge of the sample plate assembly 28 and do not protrude outward from their positions in the engaged state.

Therefore, as illustrated in FIG. 16, when the sample mounting portion 27 mounts multiple sample plate assemblies 28, it is possible to avoid interference between the sample plate assembly 28 and the holding portions 51L and 51R, even if the holding portions 51L and 51R ascend from below. An interval between the slit portions 40 can be decreased, making it possible to decrease an interval between the sample plate assemblies 28 mounted on the sample mounting portion 27.

### Summary of First Embodiment

As described above, the electrophoresis device 1 according to the first embodiment includes the sample plate assembly 28 as a container for accommodating a sample or a reagent, the stage 34 to mount the sample plate assembly 28, and the autosampler 25 to move the stage 34 at least in the horizontal direction. The electrophoresis device 1 also includes the holding portions 51L and 51R, as engagement members, to toggle between an engaged state of engaging the sample plate assembly 28 with the stage 34 and a disengaged state of disengaging the sample plate assembly 28 from the stage 34, and the holding portion open-close mechanism 47, as a toggle mechanism, that allows the holding portions 51L and 51R to toggle between the engaged state and the disengaged state.

The holding portion open-close mechanism 47 toggles the states of the holding portions 51L and 51R in conjunction with the movement of the stage 34 between the first and second positions that are located between the transfer area and the connection area. When the stage 34 is positioned on one side of the X-axis trajectory, the holding portions 51L and 51R enter the disengaged state. When the stage 34 is positioned on the other side of the X-axis trajectory, the holding portions 51L and 51R enter the engaged state.

The stage 34 moves horizontally between one side of the X-axis trajectory and the first position while the holding portions 51L and 51R remain in the disengaged state. The stage 34 moves horizontally between the other side of the X-axis trajectory and the second position while the holding portions 51L and 51R remain in the engaged state.

When the capillary 6 is removed from the opening of the septum 31 in the connection area, the holding portions 51L and 51R fasten the sample plate assembly 28 onto the stage 34, making it possible to prevent the sample plate assembly 28 from lifting from the stage 34. The electrophoresis device 1 can ensure high robustness against the removal of the capillary 6. The transfer area ensures the disengaged state. The sample plate assembly 28 can be appropriately transferred while avoiding interference between the sample plate assembly 28 and the holding portions 51L and 51R, for example.

The holding portion open-close mechanism 47 operates in conjunction with the movement of the stage 34, eliminating the need for an additional power source to drive the holding portions 51L and 51R. A small and simple structure can achieve operations in conjunction with the movement of the stage 34. Space can be saved and costs can be reduced without the need for a drive source such as an electric actuator and wiring or a control circuit for the drive source. The electrophoresis device 1 is available based on a small and simple structure.

The stage 34 moves horizontally while maintaining the disengaged state or engaged state on both sides of the horizontal trajectory. The opening degree of the holding portions 51L and 51R does not change substantially, maintaining the holding nails 67L and 67R in an approximately constant state. Unlike Patent Literatures 1 through 3, it is possible to decrease the effects of positional errors or displacement errors in the sample plate assembly 28. The connection area can ensure the fastened state of the sample plate assembly 28. The transfer area eliminates the need for precise alignment for preparing the sample plate assembly 28. The holding portions 51L and 51R operate at a low speed. It is possible to reliably ensure the displacement of the holding nails 67L and 67R with a small force and reduce the impact on the surroundings. It is possible to provide the electrophoresis device 1 with reduced errors and high reliability.

In the electrophoresis device 1 according to the first embodiment, the holding portions 51L and 51R are positioned symmetrically and driven symmetrically. The sample plate assembly 28 can be stably fastened without imbalance from a structural or mechanical standpoint.

The holding nails 67L and 67R can extend horizontally by rotation around the second support shafts 65L and 65R to prevent the sample plate assembly 28 mounted on the stage 34 from lifting upward due to the frictional force between the capillary 6 and the sample plate assembly 28. The holding nails 67L and 67R enter the engaged state by being inserted into, from the inside to the outside, and enter the disengaged state by being removed from, from the outside to the inside, the holding nail engaging holes 33L and 33R provided on the side faces of the sample adapter 29.

According to a planar view, the holding portions 51L and 51R are provided to extend upward from just below the sample adapter 29 inside its outer edge, pass through the opened bottom face of the sample adapter 29, and reach inward of the holding nail engaging holes 33L and 33R. The holding portions 51L and 51R are moved by the second support shafts 65L and 65R, positioned inside the holding nail engaging holes 33L and 33R.

According to a planar view, the holding portions 51L and 51R and the holding nails 67L and 67R move inside, narrowing the operating range. It is possible to avoid interference between the sample plate assemblies 28 and the holding portions 51L and 51R even if multiple sample plate assemblies 28 are placed in parallel in the transfer area. It is possible to decrease the interval between the sample plate assemblies 28 mounted on the sample mounting portion 27 and reduce the overall width of the sample mounting portion 27. The electrophoresis device 1 can be downsized.

The holding nails 67L and 67R are provided to be able to extend horizontally by rotation around the second support shafts 65L and 65R and each include the bottom face that touches the lower inner walls of the holding nail engaging holes 33L and 33R. Unlike Patent Literature 1, it is possible to reliably apply at least a downward force to the sample plate assembly 28 when the capillary 6 inserted into the sample plate assembly 28 is removed. The sample plate assembly 28 can be effectively prevented from lifting.

The holding nails 67L and 67R can include the bent portion 80. When the holding nails 67L and 67R are going to slip from the holding nail engaging holes 33L and 33R, it is possible to generate a reaction force in the direction along which the holding nails 67L and 67R are inserted into the holding nail engaging holes 33L and 33R. The holding nails 67L and 67R in the engaged state are hardly disengaged accidentally, reliably fastening the sample plate assembly 28. The highly reliable electrophoresis device 1 can be provided in terms of preventing the sample plate assembly 28 from lifting or slipping even if a large force is applied to remove the sample plate assembly 28 or an accidental force is applied.

In the electrophoresis device 1 according to the first embodiment, the toggle mechanism uses the cam member 72 including the inclined cam surface 73 formed along the trajectory of the stage 34 and the holding portion open-close mechanism 47 including the holding portions 51L and 51R and the cam roller 60. The mechanical mechanism can operate the holding portions 51L and 51R without using a powered actuator or power source. It is possible to prevent the sample plate assembly 28 from lifting based on a simple structure that reduces costs and is appropriate for downsizing.

In the electrophoresis device 1 according to the first embodiment, the sample adapter 29, which is fastened by the holding nails 67L and 67R, includes holding nail engaging holes 33L and 33R for inserting the holding nails 67L and 67R. It is possible to eliminate the need to provide a flange or groove on the container to be fastened, as described in Patent Literature 3. It is possible to ensure the compatibility of the sample plate assembly 28, which serves as a container for samples, for example.

The above description explains the example of the sample plate assembly 28 as a container to be prevented from lifting. The container to be prevented from lifting may be represented as the cathode-side buffer container 13 or the sample plate 30 according to the other configurations, for example. Prevention against the lift of the cathode-side buffer container 13 can be applied to cases where analysis is performed while switching between multiple cathode-side buffer containers 13. Similar to the sample plate assembly 28, the cathode-side buffer container 13 can also be transported by the autosampler 25, instead of the buffer transport portion 26.

### Second Embodiment

According to the second embodiment, the electrophoresis device 1 uses the engagement member represented by the holding portions 51L and 51R that open and close while rotating around the central axis parallel to the horizontal direction. The toggle mechanism for toggling the states of the engagement member uses a magnetic mechanism that operates by magnetic force in conjunction with the movement of the stage 34. The cam mechanism described above is replaced by a pair of magnetic members for operation. One of the magnetic members on the driven side replaces the cam roller 60 and is provided for the holding portion open-close mechanism 47 that moves with the stage 34. The other of the magnetic members on the driving side replaces the cam member 72 and is provided on the trajectory of the stage 34 in the X-axis direction.

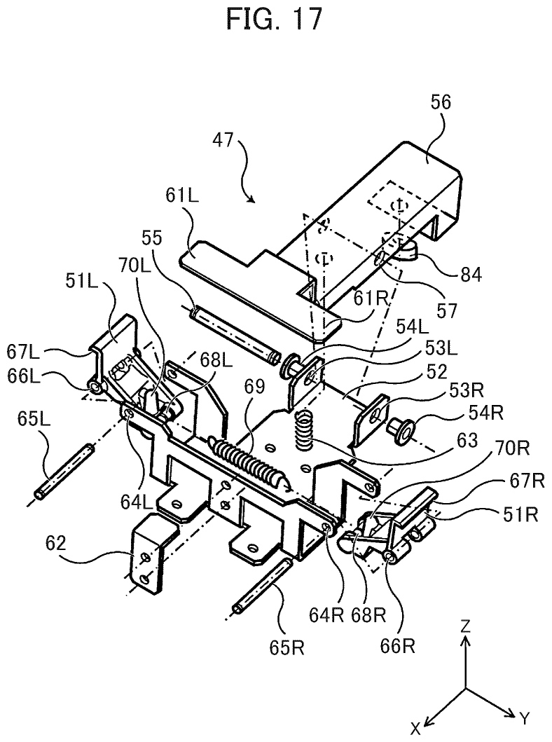

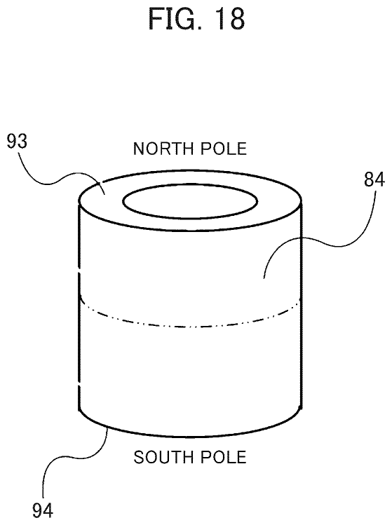

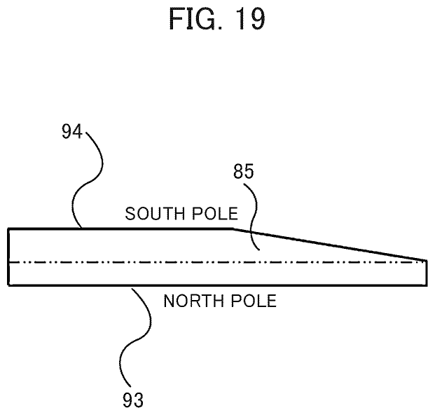

FIG. 17 is an exploded perspective view of the holding portion open-close mechanism equipped with a magnetic member. FIG. 18 is a diagram illustrating a magnetic member and magnetic poles functioning as a driven side. FIG. 19 is a diagram illustrating a magnetic member and magnetic poles functioning as a driving side. FIG. 17 is an exploded perspective view of the holding portion open-close mechanism 47 including the holding portions 51L and 51R and the magnetic members.

As illustrated in FIG. 17, the holding portion open-close mechanism 47 includes a pair of left and right holding portions 51L and 51R as the engagement members that fasten the sample plate assembly 28. According to the second embodiment, the holding portion open-close mechanism 47 includes a first magnet 84, a magnetic member, instead of the cam roller 60, on the opposite side of the holding portions 51L and 51R.

As illustrated in FIG. 18, the first magnet 84 is structured to include two types of magnetic poles 93 and 94 along one axis direction so that one surface corresponds to a single magnetic pole. In FIG. 18, the first magnet 84 is polarized vertically. The upper magnetic pole 93 corresponds to the N pole. The lower magnetic pole 94 corresponds to the S pole. The first magnet 84 is positioned so that the two magnetic poles 93 and 94 are aligned along a direction perpendicular to the bottom face of the oscillating member 56.

The first magnet 84 is secured to the bottom face of the oscillating member 56, rearward of the second support shaft hole 57 of the oscillating member 56. The first magnet 84 is installed at a location where it passes directly above a second magnet 85. Any shape and any number of first magnets 84 can be installed on the bottom face of the oscillating member 56.

As illustrated in FIG. 19, when viewed from the side, the second magnet 85 is shaped into an approximate trapezoid whose one side tilts along the longitudinal direction. The second magnet 85 is structured to include two types of magnetic poles 93 and 94 vertically so that the inclined surface provides a single magnetic pole. In FIG. 19, the second magnet 85 includes the upper magnetic pole 93 as the S pole and the lower magnetic pole 94 as the N pole.

The second magnet 85 is fixed at one end of the X-axis drive base 43, close to the slit portion 40 of the sample mounting portion 27. The second magnet 85 is installed so that the tilt direction is parallel to the X-axis trajectory of the stage 34 formed by the X-axis guide rail 44.

The first magnet 84 and the second magnet 85 are positioned so that their magnetic poles of the same polarity face each other. When the first magnet 84 or the second magnet 85 is used, the oscillating member 56 and the X-axis drive base 43 are preferably made of a non-magnetic material to avoid the influence of unintended magnetic forces. Non-magnetic materials include brass, aluminum alloy, austenitic stainless steel, ceramics, and resin, for example.

The use of the first magnet 84 and the second magnet 85 generates a mutually repulsive magnetic force to drive and ascend the rear side of the oscillating member 56. The second magnet 85 includes a single tilted magnetic pole and can gradually ascend the rear side of the oscillating member 56 in conjunction with the movement of the stage 34. Therefore, the states of the holding portions 51L and 51R are gradually changed.

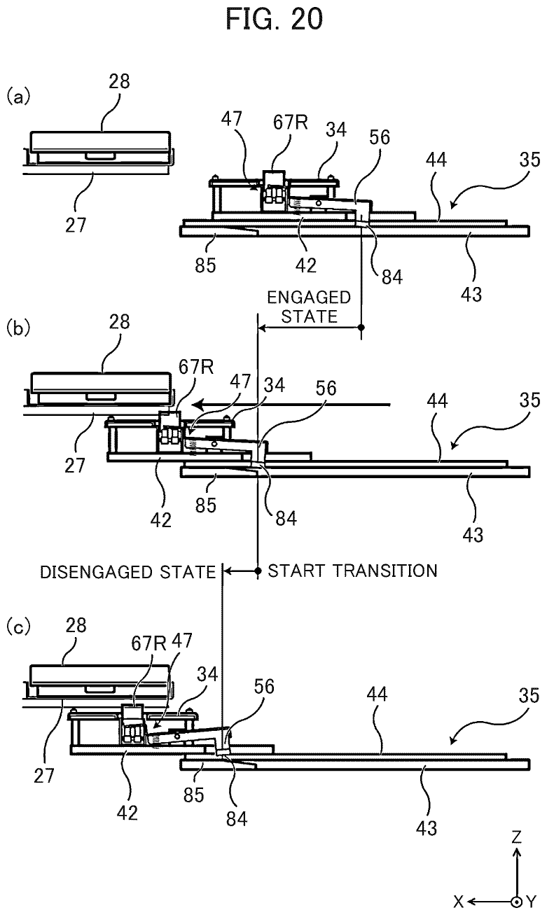

FIG. 20 is a diagram illustrating the operation of the holding portion open-close mechanism equipped with the magnetic member. FIG. 20 illustrates the periphery of the holding portion open-close mechanism 47 that supports the stage 34, as viewed from the Y-axis direction. The time-based process of transporting the stage 34 follows (a), (b), and (c) sequentially in FIG. 20.

The sample plate assembly 28 is mounted on the sample mounting portion 27 and then transferred onto the stage 34. The stage 34 is controlled to be lower than the bottom face of the sample plate assembly 28 mounted on the sample mounting portion 27 and then transported downwards from the sample mounting portion 27 by the drive of the X-axis drive portion 35.

As illustrated in (a) of FIG. 20, the stage 34 is away from the sample mounting portion 27. In this state, the first magnet 84 is positioned behind the second magnet 85. The first magnet 84 is not repelled by the magnetic force of the second magnet 85. At this moment, the holding nails 67L and 67R remain in an engaged state.

As illustrated in (b) of FIG. 20, the stage 34 approaches the sample mounting portion 27. The first magnet 84 is repelled by the magnetic interaction with the second magnet 85 and starts to ascend along the second magnet 85. At this moment, the holding nails 67L and 67R start to transition from the engaged state to the disengaged state.

As illustrated in (c) of FIG. 20, the stage 34 further approaches the sample mounting portion 27. The first magnet 84 stops ascending along the second magnet 85. At this moment, the holding nails 67L and 67R stop transitioning from the engaged state to the disengaged state and enter the disengaged state.

Then, the stage 34 ascends and descends relative to the sample mounting portion 27. The sample plate assembly 28 mounted on the sample mounting portion 27 is transferred onto the stage 34. Then, the stage 34 is transported toward the rear of the sample mounting portion 27. The first magnet 84 descends to its original height while interacting with the second magnet 85 due to the magnetic force. The holding nails 67L and 67R transition from the disengaged state to the engaged state.

### Summary of Second Embodiment

As above, the electrophoresis device 1 according to the second embodiment, similar to the electrophoresis device 1 according to the first embodiment, includes the sample plate assembly 28, the stage 34, and the autosampler 25. It includes the holding portions 51L and 51R and the holding portion open-close mechanism 47.

Therefore, the electrophoresis device 1 according to the second embodiment can achieve the same effect as the electrophoresis device 1 according to the first embodiment based on the holding portions 51L and 51R and the holding portion open-close mechanism 47, for example.

In the electrophoresis device 1 according to the second embodiment, the toggle mechanism uses the holding portion open-close mechanism 47 including the first magnet 84 and the second magnet 85 placed along the trajectory of the stage 34. The holding portions 51L and 51R can be operated by a magnetic force in conjunction with the movement of the stage 34 without using a powered actuator or power source. It is possible to avoid wear and dust generation due to sliding between members. It is possible to maintain clean conditions inside the electrophoresis device 1 and improve the maintenance-free performance of the electrophoresis device 1.

### Third Embodiment

According to the third embodiment, the electrophoresis device 1 uses the engagement member represented by engagement blades 87L and 87R that rotate around a central axis perpendicular to the horizontal direction. A rotation mechanism that rotates in conjunction with the movement of the stage 34 is used as a toggle mechanism that toggles the states of the engagement members. Supporting posts 86L and 86R that move with the stage 34 support the engagement blades 87L and 87R along with the drive blades 88L and 88R as driving members. A guide member 90 that guides the rotation of the drive blades 88L and 88R is provided on the trajectory of the stage 34 in the X-axis direction.

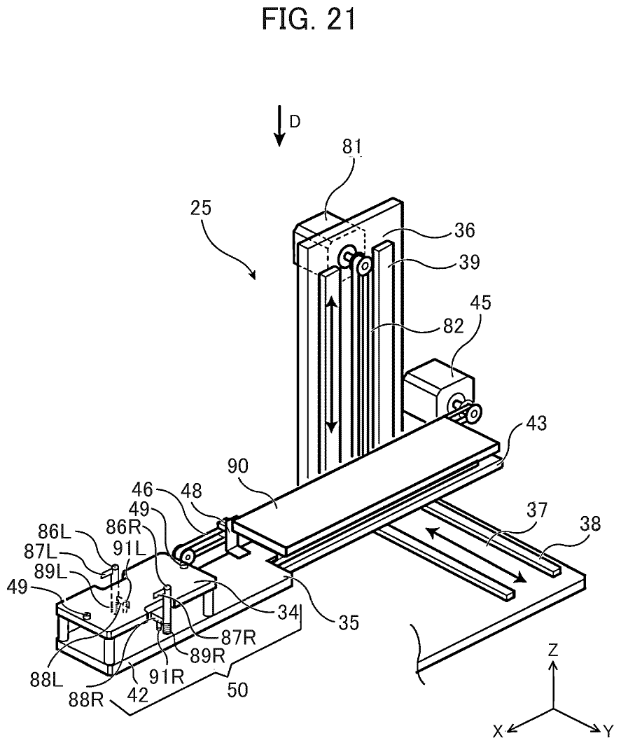

FIG. 21 is a perspective view illustrating an autosampler provided for the electrophoresis device. FIG. 21 shows a partial cutaway view of an example structure of the autosampler 25 included in the electrophoresis device 1.

As illustrated in FIG. 6, the autosampler 25 includes the sliding portion 50 moving along with the stage 34, the X-axis drive portion 35, the Z-axis drive portion 36, and the Y-axis drive portion 37, for example.

In the electrophoresis device 1 according to the third embodiment, the supporting posts 86L and 86R are erected on the stage base 42. The supporting posts 86L and 86R are provided symmetrically on the left and right sides of the stage 34 to move integrally with the stage 34. The supporting posts 86L and 86R are provided to a length that protrudes upward beyond the stage 34. The supporting posts 86L and 86R are provided to be rotatable around their central axes along the longitudinal direction of the supporting posts 86L and 86R.

The supporting posts 86L and 86R support the engagement blades 87L and 87R and the drive blades 88L and 88R. The engagement blades 87L and 87R and the drive blades 88L and 88R are provided to extend laterally to protrude in a direction perpendicular to the central axes of the supporting posts 86L and 86R. Torsion springs 89L and 89R, as torsional elastic members, are attached to the drive blades 88L and 88R. Rotation stoppers 91L and 91R are provided near the supporting posts 86L and 86R.

The engagement blades 87L and 87R are supported at a height that allows them to enter the holding nail engaging holes 33L and 33R of the sample adapter 29 placed on the stage 34. The engagement blades 87L and 87R rotate around the supporting posts 86L and 86R and are rotatably supported by them to be able to enter the holding nail engaging holes 33L and 33R. The engagement blades 87L and 87R enter and engage with the holding nail engaging holes 33L and 33R to fasten the sample plate assembly 28 onto the stage 34.

The drive blades 88L and 88R are supported at a height that allows them to touch the guide member 90. When the stage 34 is transported rearward on the X-axis drive base 43, the drive blades 88L and 88R touch the guide member 90 and rotate around the supporting posts 86L and 86R at a predetermined angle. The rotation of the drive blades 88L and 88R around the supporting posts 86L and 86R drives the engagement blades 87L and 87R to enter the holding nail engaging holes 33L and 33R.

The engagement blades 87L and 87R and the drive blades 88L and 88R can be formed into any appropriate shape, such as a plate or rod. The engagement blades 87L and 87R are provided to a length that allows them to enter the holding nail engaging holes 33L and 33R provided in the side face of the sample adapter 29.

The engagement blades 87L and 87R and the drive blades 88L and 88R are favorably provided at an angle that allows them to be approximately perpendicular to each other according to a planar view. The angle between the engagement blade 87L or 87R and the drive blade 88L or 88R is favorably set to 60 degrees or more and 120 degrees or less, more favorably 80 degrees or more and 100 degrees or less, and even more favorably approximately 90 degrees, for example. Such angles can allow the engagement blades 87L and 87R to interlock with the drive blades 88L and 88R and reliably enter the holding nail engaging holes 33L and 33R.

It would be advantageous that the engagement blades 87L and 87R are shaped to extend laterally and respectively include a flat bottom face formed to be able to touch the lower inner wall of the holding nail engaging holes 33L and 33R. Such a shape enables the engagement blades 87L and 87R, when laterally entering the holding nail engaging holes 33L and 33R, to apply a downward force to the lower inner wall of the holding nail engaging holes 33L and 33R. The sample plate assembly 28 can be effectively prevented from lifting.

The torsion springs 89L and 89R are secured to the drive blades 88L and 88R at one end and to the stage base 42 at the other end. When the drive blades 88L and 88R rotate around the supporting posts 86L and 86R, the torsion springs 89L and 89R apply a force to the drive blades 88L and 88R around the supporting posts 86L and 86R so that the drive blades 88L and 88R return to their original positions. When the supporting posts 86L and 86R are rotatable, the torsion springs 89L and 89R drive the engagement blades 87L and 87R to be extracted from the holding nail engaging holes 33L and 33R.

The guide member 90 is provided above the rear of the X-axis drive base 43. The guide member 90 is secured above the X-axis drive base 43 to maintain a specified height from the top face of the X-axis drive base 43. The guide member 90 is positioned along the X-axis direction to align its side face parallel to the X-axis direction and maintain a height that does not interfere with the stage 34 transported on the X-axis drive base 43.

The guide member 90 guides the rotation of the drive blades 88L and 88R. The front end of the guide member 90 starts guiding the drive blades 88L and 88R. The side faces of the guide member 90 are parallel to the X-axis direction, maintaining the drive blades 88L and 88R at a predetermined angle around the supporting posts 86L and 86R. The front end of the guide member 90 is positioned rearward of the transfer area and forward of the connection area in the X-axis direction.

In FIG. 21, the guide member 90 is provided as a single flat plate. Alternatively, the guide member 90 can also be provided as two rails parallel to the X-axis direction on both the right and left sides of the stage base 42.

The rotation stoppers 91L and 91R are provided on the stage base 42. The rotation stoppers 91L and 91R are provided symmetrically on the right and left sides of the stage 34 near the supporting posts 86L and 86R. The rotation stoppers 91L and 91R are provided to protrude upward from the drive blades 88L and 88R. The drive blades 88L and 88R rotate due to a force applied by the torsion springs 89L and 89R and stop at a predetermined initial position by the rotation stoppers 91L and 91R.

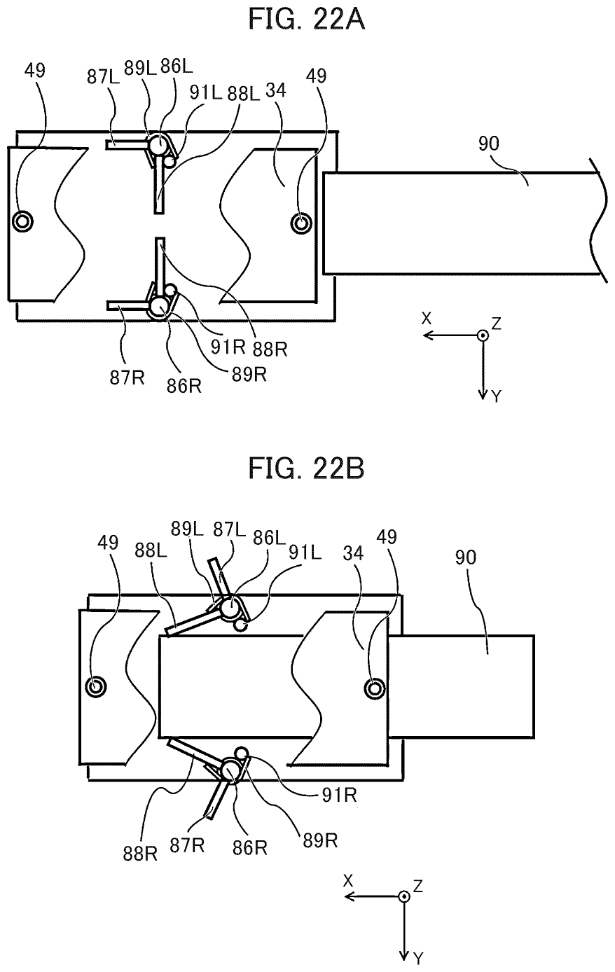

FIG. 22A is a plan view illustrating the rotation mechanism in a disengaged state. FIG. 22A is a plan view illustrating the rotation mechanism in an engaged state. FIGS. 22A and 22B illustrate the operation of the rotation mechanism including such as the supporting posts 86L and 86R, the engagement blades 87L and 87R, and the drive blades 88L and 88R, moving along with the stage 34 relative to the guide member 90. FIGS. 22A and 22B correspond to a view from direction D in FIG. 21. In FIGS. 22A and 22B, the sample mounting portion 28 that is partially perspective and mounted on the stage 34, are omitted.

As illustrated in FIG. 22A, when the stage 34 is positioned toward the transfer area, the drive blades 88L and 88R are aligned in the Y-axis direction and stay in their initial positions before rotating around the supporting posts 86L and 86R. The engagement blades 87L and 87R are aligned in the X-axis direction and stay in their initial positions before rotating around the supporting posts 86L and 86R. The drive blades 88L and 88R do not touch the guide member 90 and are not applied with an elastic force by the torsion springs 89L and 89R. This signifies a disengaged state in which the engagement blades 87L and 87R do not enter the holding nail engaging holes 33L and 33R of the sample adapter 29.

As illustrated in FIG. 22B, when the stage 34 is transported toward the connection area, the drive blades 88L and 88R move relative to the guide member 90 secured on the X-axis drive base 43. The drive blades 88L and 88R touch the guide member 90 and rotate around the supporting posts 86L and 86R by a predetermined angle. The rotation of the drive blades 88L and 88R also causes the engagement blades 87L and 87R to rotate around the supporting posts 86L and 86R by a predetermined angle. This signifies an engaged state in which the engagement blades 87L and 87R can enter the holding nail engaging holes 33L and 33R of the sample adapter 29.

When the stage 34 is transported toward the transfer area, the drive blades 88L and 88R do not touch the guide member 90, rotate around the supporting posts 86L and 86R due to the force of the torsion springs 89L and 89R, and touch the rotation stoppers 91L and 91R, returning to their initial positions. The rotation of the drive blades 88L and 88R also causes the engagement blades 87L and 87R to rotate around the supporting posts 86L and 86R, returning to their initial positions. This signifies a disengaged state in which the engagement blades 87L and 87R do not enter the holding nail engaging holes 33L and 33R of the sample adapter 29.

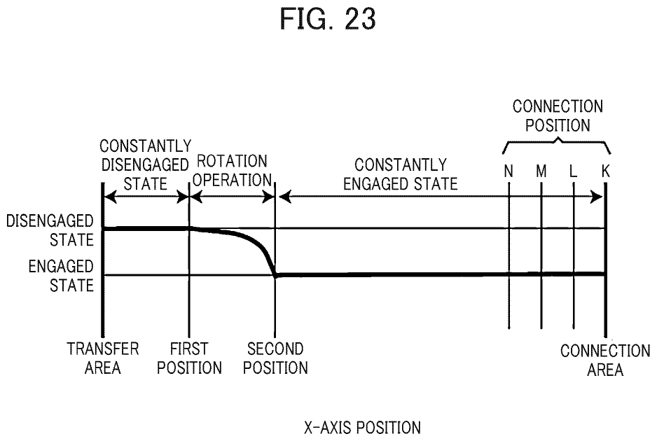

FIG. 23 is a diagram illustrating the relationship between the stage position in the X-axis direction and the engaged state of the engagement blades. In FIG. 23, the horizontal axis indicates the position of the stage 34 in the X-axis direction, and the vertical axis indicates the engaged and disengaged states of the sample adapter 29 according to the rotation of the engagement blades 87L and 87R. The left end of the horizontal axis indicates the transfer area. The right end of the horizontal axis indicates the connection area. In FIG. 23, the K position is aligned with the connection area.

As illustrated in FIG. 23, the engagement blades 87L and 87R vary the engaged state depending on how much they enter the holding nail engaging holes 33L and 33R, and toggle between the engaged state and the disengaged state in conjunction with the movement of the stage 34 in the X-axis direction. The substantially constant disengaged state is maintained toward the transfer area in the X-axis direction. On the other hand, the approximately constantly engaged state is maintained toward the connection area in the X-axis direction. The engaged state gradually varies while remaining in an intermediate state between the first and second positions, which are located between the transfer area and the connection area.

The first position corresponds to the position of the front end of the guide member 90 in the X-axis direction, namely, the position where the engagement blades 87L and 87R finish transitioning to the disengaged state and start transitioning to the engaged state. Toward the transfer area from the first position, the engagement blades 87L and 87R are completely disengaged from the holding nail engaging holes 33L and 33R, unfastening the sample plate assembly 28 from the stage 34.

The second position corresponds to the position where the drive blades 88L and 88R in contact with the guide member 90 rotate around the supporting posts 86L and 86R to the maximum angle, namely, the position where the engagement blades 87L and 87R finish transitioning to the engaged and start transitioning to the disengaged state. Toward the connection area from the second position, the engagement blades 87L and 87R fully enter the holding nail engaging holes 33L and 33R, fastening the sample plate assembly 28 onto the stage 34.

As illustrated in FIG. 23, when multiple connection positions are specified, the second position is preferably located toward the transfer area away from all the connection positions. This configuration can allow the engagement blades 87L and 87R to maintain the engaged state toward the side closer to the connection area, away from the second position. The sample plate assembly 28 can be reliably fastened onto the stage 34 at all connection positions.

### Summary of Third Embodiment

As above, the electrophoresis device 1 according to the third embodiment includes the sample plate assembly 28, the stage 34, and the autosampler 25, similar to the electrophoresis device 1 according to the first embodiment. The engagement blades 87L and 87R are included as engagement members that can toggle between the engaged state, in which the sample plate assembly 28 engages with the stage 34, and the disengaged state, in which the sample plate assembly 28 does not engage with the stage 34. The supporting posts 86L and 86R, the drive blades 88L and 88R, and the guide member 90, for example, are included as toggle mechanisms that allow the engagement blades 87L and 87R to toggle between the engaged state and the disengaged state.

The electrophoresis device 1 according to the third embodiment can achieve the same effect as the electrophoresis device 1 according to the first embodiment based on the engagement blades 87L and 87R, the supporting posts 86L and 86R, the drive blades 88L and 88R, and the guide member 90, for example.

In the electrophoresis device 1 according to the third embodiment, the toggle mechanism uses the rotation mechanism composed of the supporting posts 86L and 86R, the drive blades 88L and 88R, and the guide member 90, for example. The engagement blades 87L and 87R can operate in conjunction with the movement of the stage 34 without using a powered actuator or power source. The engagement blades 87L and 87R and the rotation mechanism operate in the horizontal direction, eliminating the need for a mechanism or space for operation in the vertical direction. It is possible to decrease the vertical thickness of the mechanism for fastening the container and ensure the compactness around the stage 34.

While the specific preferred embodiments of the present invention have been described, the invention is not limited to the embodiments but may be otherwise variously embodied within the spirit and scope of the invention. For example, the present invention is not limited to anything that may include all the configurations included in the above-described embodiments. Part of the configuration of an embodiment can be replaced by another configuration, added to other embodiments, or omitted.

For example, in FIG. 19, the second magnet 85 is formed into a tilted shape. Without using this shape, the second magnet 85 can also be configured to increase the magnetic flux density toward the transfer area on the top face. The second magnet 85 may be composed of one or more magnets. Such a configuration can gradually ascend the rear of the oscillating member 56 based on changes in the magnetic force, regardless of shape.

As illustrated in FIG. 21, the guide member 90 is provided toward the connection area or may be provided toward the transfer area in the X-axis direction, referring to the supporting posts 86L and 86R. When the guide member 90 is provided toward the transfer area, referring to the supporting posts 86L and 86R, it is possible to reverse and adjust the rotation directions of the supporting posts 86L and 86R and the positional relationship among the engagement blades 87L and 87R and the drive blades 88L and 88R.

### LIST OF REFERENCE SIGNS

1: electrophoresis device
2: capillary array
3: electrophoresis portion
4: liquid supply portion
5: irradiation detection portion
6: capillary
7: capillary head
8: load header
9: clamp plate
10: cathode electrode
11: cathode end
12: detection position
13: cathode-side buffer container
14: high-voltage supply
15: buffer solution
16: pump
17: block
18: polymer container
19: anode-side buffer container
20: polymer solution
21: anode electrode
22: light source
23: detector
24: housing
25: autosampler
26: buffer transport portion
27: sample mounting portion
28: sample plate assembly (container)
29: sample adapter
30: sample plate (container)
31: septum
32: septum clip
33: holding nail engaging hole
34: stage
35: X-axis drive portion
36: Z-axis drive portion
37: Y-axis drive portion
38: Y-axis guide rail
39: X-axis guide rail
40: slit portion
41: sample mounting portion rail
42: stage base
43: X-axis drive base
44: X-axis guide rail
45: drive source
46: X-axis drive belt
47: holding portion open-close mechanism (toggle mechanism)
48: drive connection member
49: positioning pin
50: sliding portion
51: holding portion (engagement member)
52: holding portion base member
53: first support shaft hole
54: bushing
55: first support shaft
56: oscillating member
57: second support shaft hole
58: cam roller pin hole
59: cam roller pin
60: cam roller
61: pressing portion
62: stopper
63: compression spring
64: third support shaft hole
65: second support shaft
66: fourth support shaft hole
67: holding nail (displacement suppression portion)
68: spring hook portion
69: tension spring
70: pressing protrusion portion
71: X-axis slider
72: cam member
73: inclined cam surface
74: cam surface
75: K position
76: L position
77: M position
78: N position
79: inclined surface
80: bent portion
81: drive source
82: Z-axis drive belt
83: thermostatic bath
84: first magnet (first magnetic member)
85: second magnet (second magnetic member)
86: supporting post
87: engagement blade (engagement member)
88: drive blade
89: torsion spring
90: guide member
91: rotation stopper
92: nail
93: magnetic pole (N pole)
94: magnetic pole (S pole)

1. An electrophoresis device having
a capillary,
a container for containing a sample or a reagent,
a stage for mounting the container, and
a drive portion for driving the stage at least in a horizontal direction, the electrophoresis device further comprising:
an engagement member that can toggle between an engaged state to engage the container with the stage and a disengaged state to disengage the container from the stage; and
a toggle mechanism that allows the engagement member to toggle between the engaged state and the disengaged state,
wherein, over a trajectory of the stage, one side includes a transfer area capable of transferring the container to the stage, the other side includes a connection area capable of connecting and removing the capillary to/from the container, a first position is provided between the one side and the other side, and a second position is provided between the first position and the other side;
wherein the toggle mechanism allows the engagement member to enter the disengaged state when a state of the engagement member transitions in conjunction with the movement of the stage between the first position and the second position to position the stage to the one side;
wherein the engagement member enters the engaged state when the stage is positioned to the other side; and
wherein the stage moves horizontally between the one side and the first position while maintaining the engagement member in the engaged state, and moves horizontally between the other side and the second position while maintaining the engagement member in the disengaged state.

2. The electrophoresis device according to claim 1,
wherein the toggle mechanism gradually changes the state of the engagement member while the stage moves between the first position and the second position.

3. The electrophoresis device according to claim 1, comprising:
a drive portion for driving the stage in a vertical direction,
wherein, when the stage is positioned to the one side, the engagement member ascends while maintaining the engaged state to allow the capillary to be connected to the container and, after electrophoresis using the capillary, the engagement member descends while maintaining the engaged state to allow the capillary to be removed from the container; and
wherein the stage is driven to descend such that the engagement member generates a downward force greater than a frictional force generated between the capillary and the container.

4. The electrophoresis device according to claim 3,
wherein the engagement member includes a horizontally extendable displacement suppression portion that prevents the container mounted on the stage from lifting upward due to the frictional force.

5. The electrophoresis device according to claim 4,
wherein the container includes a pair of right and left side faces parallel to the horizontal movement direction of the stage and is formed into a rectangular parallelepiped shape with an open bottom face;
wherein the right and left side faces include a pair of through-holes into which the displacement suppression portion can be inserted;
wherein the engagement member extends from directly below the container, positioned inside the outer edge of the container according to a planar view of the container, passes through the open bottom face, and reaches inside the through-hole; and
wherein the displacement suppression portion can toggle between an engaged state to be inserted into the through-hole from inside to outside and a disengaged state to be extracted toward the inside of the through-hole.

6. The electrophoresis device according to claim 5,
wherein the engagement member includes the displacement suppression portion and a bent portion that is provided at the tip end of the displacement suppression portion and protrudes in a direction perpendicular to the displacement suppression portion;
wherein the bent portion includes an inclined surface whose protrusion width protrudes in a direction perpendicular to the displacement suppression portion and increases from the base end to the tip end of the displacement suppression portion; and
wherein, when the displacement suppression portion remains in the engaged state, the inclined surface is positioned outside the through-hole according to a planar view of the container, and when the displacement suppression portion is going to be pulled out of the through-hole, touches the periphery of the through-hole, generating a reaction force in a direction in which the displacement suppression portion is inserted into the through-hole.

7. The electrophoresis device according to claim 4,
wherein the toggle mechanism includes
an oscillating member, having a support shaft extending in a direction perpendicular to the horizontal movement direction of the stage, that is provided swingably so that one side and the other side alternately seesaw around the support shaft, and includes a cam follower toward the one side, and
an inclined cam surface that is provided slantingly between the first position and the second position;
wherein the engagement member, having a support shaft extending in a direction parallel to the horizontal movement direction of the stage, is provided swingably so that one side and the other side alternately seesaw around the support shaft, and includes the displacement suppression portion toward the one side, and
wherein the cam follower ascends along the inclined cam surface due to the movement of the stage, the ascending cam follower descends the other side of the oscillating member to press the other side of the engagement member, causing one side of the engagement member to ascend, and the displacement suppression portion thereby transitions to the engaged state.

8. The electrophoresis device according to claim 4,
wherein the toggle mechanism includes
an oscillating member, having a support shaft extending in a direction perpendicular to the horizontal movement direction of the stage, that is provided swingably so that one side and the other side alternately seesaw around the support shaft, and includes a first magnetic member toward the one side, and
a second magnetic member provided between the first position and the second position;
wherein the engagement member, having a support shaft extending in a direction parallel to the horizontal movement direction of the stage, is provided swingably so that one side and the other side alternately seesaw around the support shaft, and includes the displacement suppression portion toward the one side, and
wherein the movement of the stage causes the first magnetic member and the second magnetic member to repel mutually by magnetic force, the magnetic repulsion causes the other side of the oscillating member to descend and press the other side of the engagement member, causing one side of the engagement member to ascend, and the displacement suppression portion thereby transitions to the engaged state.

9. The electrophoresis device according to claim 4,
wherein the toggle mechanism includes
a supporting post that is erected on the side of the stage and is provided rotatably around its central axis,
a driving member that extends laterally from the supporting post,
a guide member that is provided between the first position and the second position to maintain a height that enables contact with the driving member, and
a torsional elastic member that applies force to the driving member in a direction opposite to the rotation of the driving member around the supporting post,
wherein the engagement member is supported to extend laterally from the supporting post,
wherein the stage moves to move the driving member along the guide member and rotate the supporting post, causing the engagement member to rotate around the supporting post, and the displacement suppression portion thereby transitions to the engaged state.
